(19) United States
(12) Patent Application Publication
(10) Pub. No.: US 2026/0093191 A1
(43) Pub. Date: Apr. 2, 2026

(54) PARTICLES, TONER, DEVELOPER, IMAGE FORMING APPARATUS, AND IMAGE FORMING METHOD

(71) Applicants: Akio Takei, Kanagawa (JP); Masahiro Yukikawa, Kanagawa (JP); Tsuneyasu Nagatomo, Kanagawa (JP); Shinya Nakayama, Kanagawa (JP)

(72) Inventors: Akio Takei, Kanagawa (JP); Masahiro Yukikawa, Kanagawa (JP); Tsuneyasu Nagatomo, Kanagawa (JP); Shinya Nakayama, Kanagawa (JP)

(73) Assignee: Ricoh Company, Ltd., Tokyo (JP)

(21) Appl. No.: 19/324,805

(22) Filed: Sep. 10, 2025

(30) Foreign Application Priority Data
Sep. 30, 2024 (JP) 2024-171283

(51) Int. Cl. G03G 9/093

(52) U.S. Cl. CPC G03G 9/09342; G03G 9/09371

(57) ABSTRACT

Particles comprising base particles and an external additive are provided. The base particles contain a resin, and the resin comprises polyester as a main component. The polyester comprises at least one of polyethylene terephthalate and polybutylene terephthalate. The external additive is coated with a hydroxide of a metal. R1≤R2 and R3≤R4 are satisfied, where R1 [log Ωcm] is a resistance value of the external additive and R2 [log Ωcm] is a resistance value of the base particles, at 25° C. and a humidity of 50%, and R3 [log Ωcm] is a resistance value of the external additive and R4 [log Ωcm] is a resistance value of the base particles, at 40° C. and a humidity of 70%.

### CROSS-REFERENCE TO RELATED APPLICATIONS

This patent application is based on and claims priority pursuant to 35 U.S.C. § 119(a) to Japanese Patent Application No. 2024-171283, filed on Sep. 30, 2024, in the Japan Patent Office, the entire disclosure of which is hereby incorporated by reference herein.

### BACKGROUND

### Technical Field

The present disclosure relates to particles, a toner, a developer, an image forming apparatus, and an image forming method.

### Related Art

Particles containing a resin are widely used as a toner for an image forming apparatus such as a multifunction peripheral (MFP) and a printer in various places such as an office. To reduce an environmental impact by a toner, for example, a reduction of power consumption by improving a fixability of the toner at low temperatures, a reduction of energy during production, a use of biomass-derived resins derived from plants for a binder resin, a use of recycled raw materials for a binder resin, and the like are considered. Specifically, because of the increasing importance of resource and energy conservation, and a need for recycling resources, there is an increasing demand for a use of recycled raw materials for a binder resin.

### SUMMARY

Embodiments of the present invention provide particles comprising base particles and an external additive. The base particles contain a resin, and the resin comprises polyester as a main component. The polyester comprises at least one of polyethylene terephthalate and polybutylene terephthalate. The external additive is coated with a hydroxide of a metal. R1≤R2 and R3≤R4 are satisfied, where R1 [log Ωcm] is a resistance value of the external additive and R2 [log Ωcm] is a resistance value of the base particles, at 25° C. and a humidity of 50%, and R3 [log Ωcm] is a resistance value of the external additive and R4 [log Ωcm] is a resistance value of the base particles, at 40° C. and a humidity of 70%.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawing, wherein: the drawing is an image forming apparatus according to one embodiment of the present disclosure.

The accompanying drawing is intended to depict embodiments of the present disclosure and should not be interpreted to limit the scope thereof. The accompanying drawing is not to be considered as drawn to scale unless explicitly noted. Also, identical or similar reference numerals designate identical or similar components throughout the several views.

### DETAILED DESCRIPTION

In describing embodiments illustrated in the drawing, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawing, embodiments of the present disclosure are described below. As used herein, the singular forms “a”, “an”, and “the” are intended to include the plural forms as well, unless the context clearly indicates otherwise.

According to embodiments of the present disclosure, particles having low environmental impact, an excellent charging stability over time, and an excellent charging stability even in a highly humid environment are provided.

Embodiments of the present disclosure will be described in detail below. It is noted that the present embodiments are not limited to the following description, and may be modified as appropriate without departing from the spirit of the present disclosure. Herein, unless otherwise specified, the use of “to” indicating a range of values means that the values before and after “to” are included as the lower limit and upper limit.

Embodiments of the present disclosure will be described in detail below.

### (Particles)

Particles according to embodiments of the present disclosure are particles comprising base particles and an external additive. The base particles contain a resin, and the resin comprises polyester as a main component. The polyester comprises at least one of polyethylene terephthalate and polybutylene terephthalate. The external additive is coated with a hydroxide of a metal. R1≤R2 and R3≤R4 are satisfied, where R1 [log Ωcm] is s resistance value of the external additive and R2 [log Ωcm] is a resistance value of the base particles, at 25° C. and a humidity of 50%, and R3 [log Ωcm] is a resistance value of the external additive and R4 [log Ωcm] is a resistance value of the base particles, at 40° C. and a humidity of 70%.

Such particles have low environmental impact, and can provide an excellent charging stability over time, and an excellent charging stability even in a highly humid environment.

In using such particles in image formation, a high-quality image can be stably provided.

### <Base Particles>

The base particles contained in the particles according to the present disclosure include polyester as a main component, and the polyester includes at least one of polyethylene terephthalate (PET) and polybutylene terephthalate (PBT). Herein, the term “main component” refers to the component contained in the largest amount in terms of substance amount among the contained components.

### <<Polyethylene Terephthalate and Polybutylene Terephthalate>>

The particles according to the present disclosure contain at least one of the polyethylene terephthalate and the polybutylene terephthalate in the base particles. Therefore, the particles may contain a biomass-derived resin instead of a petroleum-derived resin, and are considered as particles having low environmental impact.

A molecular weight distribution, a composition, a production method, and a form during a use of the polyethylene terephthalate or the polybutylene terephthalate are not particularly limited and can be appropriately selected according to a purpose. From the viewpoint of further reducing the environmental load, it is preferable to use, for example, recycled products, or fiber waste or pellets not meeting specifications, and it is more preferable to use recycled products processed into flakes.

The weight average molecular weight (Mw) of the polyethylene terephthalate or the polybutylene terephthalate is not particularly limited and can be appropriately selected according to a purpose, but is preferably 30,000 to 100,000.

The analytical method and the calculation method for determining the content of the polyethylene terephthalate and the polybutylene terephthalate in the particles are not particularly limited, and a general calculation method can be used to determine a blended amount of the polyethylene terephthalate. An example of the analytical method and the calculation method for determining the content of the polyethylene terephthalate or the polybutylene terephthalate includes, but is not limited to, separating the polyethylene terephthalate or the polybutylene terephthalate from the particles by gel permeation chromatography (GPC) or the like, and subjecting each of the separated components to the analytical procedure described below, to calculate a mass ratio of the constituent components of the particles.

Quantitative analysis may also be performed by estimating the main constituent components from soft decomposition due to methylation of ester bonds in the particles using gas chromatography/mass spectrometry (GC/MS) at 300° C. with a reaction reagent (10% tetramethyl ammonium hydroxide (TMAH)/methanol solution) and drawing a calibration curve of total ion current chromatogram (TICC) intensity.

The components can each be separated by GPC using the following method, for example.

In the GPC measurement using tetrahydrofuran (THF) as a mobile phase, an eluate is fractionated by using a fraction collector or the like, and fractions corresponding to a desired molecular weight portion out of the total area of an elution curve are collected.

The eluate obtained by collecting such fractions is concentrated and dried using an evaporator or the like. Subsequently, a solid content is dissolved in a deuterated solvent such as deuterated chloroform or deuterated THF, and subjected to ¹H-NMR measurement. The constituent monomer ratio of the resin in the eluted components is calculated from the integrated ratio of each element.

In another method, the eluate may be concentrated, and then, hydrolyzed with sodium hydroxide or the like, to qualitatively and quantitatively analyze the decomposition products by high-performance liquid chromatography (HPLC) or the like to calculate the constituent monomer ratio.

An example of a means for separating the components contained in the particles in analyzing the particles will also be described in detail.

First, 1 g of the particles is added to 100 μmL of THF, and the mixture is stirred for 30 minutes under a condition of 25° C. to obtain a solution in which the soluble components are dissolved. The solution is filtered through a membrane filter having 0.2 μm of an opening to obtain a portion of the particles soluble in THF. Next, such a soluble portion is dissolved in THF and the resulting sample is injected into a gel permeation chromatography (GPC) capable of measuring the molecular weight. On the other hand, a fraction collector is placed at an eluate discharge port of the GPC to fractionate the eluate at each predetermined count. The eluate is collected for each 5% of the area ratio from the elution start in the elution curve (the rise of the curve).

Next, for each elution fraction, 30 μmg of a sample is dissolved in 1 μmL of deuterated chloroform, and 0.05 vol % of tetramethylsilane (TMS) is added as a standard substance. The solution is filled into a glass tube for NMR measurement having 5 mm in diameter, and a nuclear magnetic resonance device (for example, JNM-AL400 μmanufactured by JEOL Ltd.) is used at a temperature of 23° C. to 25° C. at 128 integrations to obtain a spectrum. The monomer composition and the constituent ratio of polyethylene terephthalate or the like contained in the particles can be determined from the peak integral ratio of the obtained spectrum.

The content of the polyethylene terephthalate and the polybutylene terephthalate is not particularly limited and can be appropriately selected according to a purpose, but is preferably 5 parts by mass to 70 parts by mass, and more preferably 10 parts by mass to 50 parts by mass, with respect to 100 parts by mass of the base particles. When the content of the polyethylene terephthalate and the polybutylene terephthalate is 5 parts by mass or more with respect to 100 parts by mass of the base particles, the effect of reduction in the environmental load is more easily achieved and uniformity of the particle diameter of particles can be ensured. When the content is 70 parts by mass or less, the effect of the fixability at low temperatures is more easily achieved. When the content of the polyethylene terephthalate and the polybutylene terephthalate is within the above-mentioned more preferred range, it is advantageous in that both the reduction in the environmental load of the particles and the improvement in uniformity of the particle diameter are achieved.

The mass ratio of the polyethylene terephthalate and the polybutylene terephthalate in the particles is preferably 5% or more and 70% or less of the total resin, more preferably 10% or more and less than 50%, and even more preferably 20% or more and less than 35%. When the mass ratio of the polyethylene terephthalate and the polybutylene terephthalate in the particles is 5% or more of the total resin, the effect of reduction in the environmental load is easily achieved and uniformity of the particle diameter can be ensured, and when the mass ratio is 70% or less, the effect of the fixability at low temperatures is easily achieved. When the mass ratio of the polyethylene terephthalate and the polybutylene terephthalate is within the above-mentioned more preferred range, it is advantageous in that both the reduction in the environmental load of the particles and the improvement in uniformity of the particle diameter are achieved.

The content of the polyethylene terephthalate and the polybutylene terephthalate in the particles with respect to the total mass of the base particles is preferably 30% by mass or more, more preferably 40% by mass or more, and even more preferably 50% by mass or more. When the content of the polyethylene terephthalate and the polybutylene terephthalate with respect to the total mass of the particles is 30% by mass or more, particles providing a higher effect of reduction in the environmental load can be obtained.

The base particles contained in the particles according to the present disclosure preferably include at least one of a non-crystalline resin, an amorphous resin, and a crystalline resin in addition to the polyethylene terephthalate and the polybutylene terephthalate, and more preferably, at least one of the non-crystalline resin, the amorphous resin, and the crystalline resin contains a biomass-derived resin. When the particles include at least one of a non-crystalline resin, an amorphous resin, and a crystalline resin, and at least one of the non-crystalline resin, the amorphous resin, and the crystalline resin contains a biomass-derived resin, the total content of the biomass-derived resin, the polyethylene terephthalate, and the polybutylene terephthalate with respect to the total mass of the particles is easily achieved to be 50% by mass or more, resulting in particles with a lower environmental load. The impact of the structural differences between biomass-derived resins and petroleum-derived resins on the properties of biomass-derived resin particles can be reliably reduced. Therefore, particles have a better charging stability, a greater uniformity of the particle diameter, and can more stably provide a high-quality image.

The resin contained in the particles according to the present disclosure preferably has a radioactive carbon isotope ¹⁴C concentration of 10.8 pMC or more. A radioactive carbon isotope ¹⁴C concentration of 10.8 pMC or more is preferable because it allows the particles providing a lower environmental load.

It is noted that herein, polyethylene terephthalate and polybutylene terephthalate are not included in the “amorphous resin”.

### <<Non-crystalline Resin (Prepolymer)>>

From the viewpoint of improving the fixability at low temperatures, the particles according to the present disclosure preferably contain at least one of a non-crystalline resin (prepolymer) and an extended product of the non-crystalline resin.

Examples of the reactive precursor of the non-crystalline resin (prepolymer) include, but are not limited to, polyester having a group that can react with an active hydrogen group.

Examples of the groups that can react with active hydrogen groups include, but are not limited to, an isocyanate group, an epoxy group, a carboxylic acid, and an acid chloride group. Among such groups, the isocyanate group is preferred, because it can introduce a urethane bond or a urea bond into the amorphous polyester resin.

The reactive precursor of the non-crystalline resin (prepolymer) may have a branched structure imparted by at least one of a trihydric or higher alcohol and a trivalent or higher carboxylic acid.

An example of the polyester resin having the isocyanate group may include, but is not limited to, a reaction product of a polyester resin having an active hydrogen group with a polyisocyanate.

For example, the polyester resin having an active hydrogen group may be obtained by polycondensation of a diol, a dicarboxylic acid, and at least one of a trihydric or higher alcohol and a trivalent or higher carboxylic acid. The trihydric or higher alcohol and the trivalent or higher carboxylic acid impart a branched structure to the polyester resin containing an isocyanate group.

Examples of the diol include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol; diols having an oxyalkylene group such as diethylene glycol, triethylene glycol, dipropylene glycol, polyethylene glycol, polypropylene glycol, and polytetramethylene glycol; alicyclic diols such as 1,4-cyclohexanedimethanol and hydrogenated bisphenol A; diol components obtained by adding alkylene oxides such as ethylene oxide, propylene oxide, and butylene oxide to alicyclic diols; bisphenols such as bisphenol A, bisphenol F, and bisphenol S; and alkylene oxide adducts of bisphenols obtained by adding alkylene oxides such as ethylene oxide, propylene oxide, and butylene oxide to bisphenols.

Among such diols, from the viewpoint of controlling the glass transition temperature (Tg) of an elongated product of the non-crystalline resin (prepolymer) to 20° C. or lower, it is preferable to use an aliphatic diol having 3 to 10 carbon atoms, such as 1,2-propylene glycol, 1,3-propylene glycol, 1,4-butanediol, 2-methyl-1,3-propanediol, 1,5-pentanediol, or 3-methyl-1,5-pentanediol, and it is more preferable to use 50 μmol % or more of the alcohol component in the resin. Such diols may be used alone or in combination of two or more types.

Among the above-mentioned elongated products of the non-crystalline resin (prepolymer), an elongated product in which the reactive precursor of the non-crystalline resin (prepolymer) is a polyester are referred to as amorphous polyester resin A.

### <<<Amorphous Polyester Resin A>>>

The amorphous polyester resin A includes steric hindrance in a resin chain, which reduces the melt viscosity during fixing, and thus, it is easier to obtain the fixability at low temperatures. Therefore, the main chain of the aliphatic diol preferably has a structure represented by General Formula (1) below.

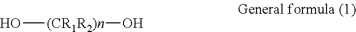

(where R₁ and R₂ each independently represent a hydrogen atom and an alkyl group having 1 to 3 carbon atoms, n represents an odd number from 3 to 9, and in n repeating units, R₁ and R₂ may be the same or different.)

Here, the main chain of the aliphatic diol refers to the carbon chain in which two hydroxyl groups contained in the aliphatic diol are linked via the lowest number of carbon atoms. It is preferable that the main chain has an odd number of carbon atoms, because the odd-even properties reduce a crystallinity. It is more preferable that the side chain has at least one or more alkyl groups having 1 to 3 carbon atoms, because the interaction energy between molecules in the main chain is reduced by the stereoscopic properties.

Examples of dicarboxylic acids include, but are not limited to, aliphatic dicarboxylic acids such as succinic acid, adipic acid, sebacic acid, dodecanedioic acid, maleic acid, and fumaric acid; and aromatic dicarboxylic acids such as phthalic acid, isophthalic acid, terephthalic acid, and naphthalenedicarboxylic acid. Anhydrides, lower (number of carbon atoms from 1 to 3) alkyl esters, and halides of such compounds may also be used. Among such dicarboxylic acids, from the viewpoint of controlling the glass transition temperature (Tg) of the amorphous polyester resin A to 20° C. or lower, aliphatic dicarboxylic acids having 4 to 12 carbon atoms are preferred, and it is more preferable to use 50% by mass or more of the carboxylic acid components in the resin. Such dicarboxylic acids may be used alone or in combination of two or more types.

Examples of the trihydric or higher alcohols include, but are not limited to, trihydric or higher aliphatic alcohols such as glycerin, trimethylolethane, trimethylolpropane, pentaerythritol, and sorbitol; trihydric or higher polyphenols such as trisphenol PA, phenol novolac, and cresol novolac; and alkylene oxide adducts of trihydric or higher polyphenols, such as adducts obtained by adding alkylene oxides such as ethylene oxide, propylene oxide, and butylene oxide to trihydric or higher polyphenols.

Examples of trivalent or higher carboxylic acids include, but are not limited to, trivalent or higher aromatic carboxylic acids, and preferred examples include, but are not limited to, trivalent or higher aromatic carboxylic acids having 9 to 20 carbon atoms, such as trimellitic acid and pyromellitic acid. Anhydrides, lower (number of carbon atoms from 1 to 3) alkyl esters, and halides of such compounds may also be used.

Examples of the polyisocyanate include, but are not limited to, diisocyanates and trivalent or higher isocyanates.

The polyisocyanate is not particularly limited and can be appropriately selected depending on the purpose. Examples of the polyisocyanate include, but are not limited to, 1,3- and/or 1,4-phenylene diisocyanate, 2,4- and/or 2,6-tolylene diisocyanate (TDI), crude TDI, 2,4′- and/or 4,4′-diphenylmethane diisocyanate (MDI), crude MDI [phosgenates of crude diaminophenylmethane [condensation product of formaldehyde and aromatic amine (aniline) or a mixture thereof, diaminodiphenylmethane and a small amount (for example, 5 to 20% by mass) of a trifunctional or higher functional polyamine], polyallyl polyisocyanate (PAPI), 1,5-naphthylene diisocyanate, 4,4′,4″-triphenylmethane triisocyanate, aromatic diisocyanates such as m- and p-isocyanatophenylsulfonyl isocyanate, ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, aliphatic diisocyanates such as lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; cycloaliphatic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- and 2,6-norbornane diisocyanate; aromatic aliphatic diisocyanates such as m- and p-xylylene diisocyanate (XDI) and α,α,α′,α′-tetramethylxylylene diisocyanate (TMXDI); trivalent or higher polyisocyanates such as lysine triisocyanate and diisocyanate-modified products of trivalent or higher alcohols; and modified products of such isocyanates, and mixtures of two or more of such polyisocyanates may also be used. Examples of the modified products of the isocyanates include, but are not limited to, modified products containing a urethane group, a carbodiimide group, an allophanate group, a urea group, a burette group, a uretdione group, a uretimine group, an isocyanurate group, and an oxazolidone group.

### <<Amorphous Resin>>

For example, the amorphous resin that can be included in the present disclosure is preferably a terpene resin and an amorphous polyester resin, and an amorphous polyester resin other than the above-mentioned amorphous polyester resins is referred to as “amorphous polyester resin B”.

### <<<Amorphous Polyester Resin B>>>

The amorphous polyester resin B is preferably a linear polyester resin, and preferably an unmodified polyester resin. It is noted that the term “linear polyester” means “straight-chain polyester”, and the term “non-linear polyester” means “non-straight chain polyester”.

The unmodified polyester resin is a polyester resin obtained by using a polyhydric alcohol and a polycarboxylic acid or a derivative thereof, such as polycarboxylic acids, polycarboxylic anhydrides, and polycarboxylic esters, and is not modified with an isocyanate compound or the like.

The amorphous polyester resin B preferably does not contain a urethane bond or a urea bond.

The amorphous polyester resin B contains a dicarboxylic acid component as a constituent component, and the dicarboxylic acid component preferably contains 50 μmol % or more of terephthalic acid. This is advantageous from the viewpoint of heat-resistant storage stability.

An Example of the polyhydric alcohol includes, but is not limited to, diols.

Examples of the diols include, but are not limited to, alkylene (number of carbon atoms from 2 to 3) oxide (average number of moles added: 1 to 10) adducts of bisphenol A such as polyoxypropylene (2.2)-2,2-bis(4-hydroxyphenyl)propane and polyoxyethylene (2.2)-2,2-bis(4-hydroxyphenyl)propane; ethylene glycol, neopentyl glycol, propylene glycol; hydrogenated bisphenol A, and alkylene (number of carbon atoms from 2 to 3) oxide (average number of moles added: 1 to 10) adducts of hydrogenated bisphenol A. Such diols may be used alone or in combination of two or more types.

Among such diols, it is preferable to contain ethylene glycol or propylene glycol, and it is more preferable to contain plant-derived ethylene glycol or propylene glycol.

Examples of polycarboxylic acids include, but are not limited to, dicarboxylic acids.

Examples of dicarboxylic acids include, but are not limited to, adipic acid, phthalic acid, isophthalic acid, terephthalic acid, fumaric acid, maleic acid; succinic acids substituted with an alkyl group having 1 to 20 carbon atoms or an alkenyl group having 2 to 20 carbon atoms, such as dodecenylsuccinic acid and octylsuccinic acid; and modified purified rosin. The modified purified rosin is preferably rosin modified with acrylic acid, fumaric acid, or maleic acid.

Among such dicarboxylic acids, dicarboxylic acids including plant-derived saturated aliphatic succinic acid and modified purified rosin are preferable. When a plant-derived product is used, the carbon neutrality can be improved. The saturated aliphatic group provides an effect of increasing the recrystallization properties of the crystalline polyester resin, and thus, the aspect ratio of the crystalline polyester resin increases, and the fixability at low temperatures improves.

The saturated aliphatic group may be used alone or in combination of two or more types.

For the purpose of adjusting an acid value and a hydroxyl value, the amorphous polyester resin B may include at least one of a trivalent or higher carboxylic acid and a trihydric or higher alcohol at an end of the resin chain.

Examples of trivalent or higher carboxylic acids include, but are not limited to, trimellitic acid, pyromellitic acid, and acid anhydrides thereof.

Examples of trihydric or higher alcohols include, but are not limited to, glycerin, pentaerythritol, and trimethylolpropane.

The molecular weight of the amorphous polyester resin B is not particularly limited and can be appropriately selected according to a purpose. The weight average molecular weight (Mw) of the amorphous polyester resin B measured by gel permeation chromatography (GPC) is preferably from 3,000 to 10,000. The number average molecular weight (Mn) of the amorphous polyester resin B is preferably from 1,000 to 4,000. A ratio Mw/Mn of the weight average molecular weight (Mw) to the number average molecular weight (Mn) of the amorphous polyester resin B is preferably 1.0 to 4.0.

When the weight average molecular weight (Mw) or the number average molecular weight (Mn) of the amorphous polyester resin B is equal to or greater than the above-mentioned lower limit, a decrease in the heat-resistant storage stability of the particles and a decrease in the durability against stress such as stirring in a developing device can be reduced. When the weight average molecular weight (Mw) or the number average molecular weight (Mn) of the amorphous polyester resin B is equal to or less than the above-mentioned upper limit, an increase in the viscoelasticity of the particles when melted and a decrease in fixability at low temperatures can be reduced.

The weight average molecular weight (Mw) of the amorphous polyester resin B is more preferably from 4,000 to 7,000. The number average molecular weight (Mn) of the amorphous polyester resin B is more preferably from 1,500 to 3,000. A ratio Mw/Mn of the weight average molecular weight (Mw) to the number average molecular weight (Mn) of the amorphous polyester resin B is more preferably 1.0 to 3.5.

The acid value of the amorphous polyester resin B is not particularly limited and can be appropriately selected according to a purpose, but is preferably from 1 μmgKOH/g to 50 mgKOH/g, and more preferably 5 μmgKOH/g to 30 μmgKOH/g. When the acid value of the amorphous polyester resin B is 1 μmgKOH/g or more, the particles easily take a negative chargeability, and further, when the particles are fixed to a medium to be formed with an image such as paper, the affinity between the medium to be formed with an image and the particles is improved, so that the fixability at low temperatures can be improved. When the acid value of the amorphous polyester resin B is 50 μmgKOH/g or less, a decrease in charging stability, particularly in charging stability for environmental fluctuations can be reduced.

The hydroxyl value of the amorphous polyester resin B is not particularly limited and may be appropriately selected according to a purpose, but is preferably 5 μmgKOH/g or more. The hydroxyl value of the amorphous polyester resin B is preferably 5 μmgKOH/g or more because the particle diameter of the base particles tends to be uniform at such a value.

The glass transition temperature (Tg) of the amorphous polyester resin B is preferably from 40° C. to 80° C., and more preferably from 50° C. to 70° C. When the glass transition temperature (Tg) of the amorphous polyester resin B is 40° C. or higher, the particles have a sufficient heat-resistant storage stability and durability against stress such as stirring in a developing device, and also have a good filming resistance. When the glass transition temperature (Tg) of the amorphous polyester resin B is 80° C. or lower, the particles are sufficiently deformed by the application of heat and pressure during fixing, and thus, a good fixability at low temperatures is obtained.

The molecular structure of the amorphous polyester resin B can be confirmed by an NMR measurement of a solution or a solid, as further, by X-ray diffraction, GC/MS, LC/MS, and IR measurements. An example of a method includes, but is not limited to, a method of simply detecting, as the amorphous polyester resin B, a resin that does not absorb at 965±10 cm⁻¹ and 990±10 cm⁻¹ from 6CH (out-of-plane bending vibration) of an olefin in an infrared absorption spectrum.

The content of the amorphous polyester resin B is not particularly limited and can be appropriately selected according to a purpose, but is preferably 50 parts by mass to 90 parts by mass, and more preferably 60 parts by mass to 80 parts by mass, with respect to 100 parts by mass of the particles. When the content of the amorphous polyester resin B is 50 parts by mass or more with respect to 100 parts by mass of the particles, a deterioration in the dispersibility of colorants and release agents in the particles can be prevented, and the occurrence of fogging and distortion of the image can be prevented. When the content of the amorphous polyester resin B is 90 parts by mass or less with respect to 100 parts by mass of the particles, the contents of the crystalline polyester resin C and the amorphous polyester resin B described below can be prevented from decreasing, and thus, a decrease in the fixability at low temperatures can be reduced. When the content of the amorphous polyester resin B is within the above-mentioned more preferred range, it is advantageous in that both the high image quality and the excellent fixability at low temperatures can be obtained.

### <<Crystalline Resin>>

From the viewpoint of improving the fixability at low temperatures, the particles according to the present disclosure preferably contain a crystalline resin.

The crystalline resin is not particularly limited and can be appropriately selected according to a purpose, as long as the crystalline resin has a crystallinity. Examples of the crystalline resin include, but are not limited to, polyester resins, polyurethane resins, polyurea resins, polyamide resins, polyether resins, vinyl resins, and modified crystalline resins. Such crystalline resins may be used alone or in combination of two or more types.

In the present disclosure, the polyester resin used as the crystalline resin is referred to as the “crystalline polyester resin C”. The crystalline polyester resin C will be described below.

### <<<Crystalline Polyester Resin C>>>

The crystalline polyester resin C has a high crystallinity, and thus, exhibits heat-melting properties showing a rapid change in viscosity near a fixing start temperature.

When the crystalline polyester resin C having such characteristics is used together with the amorphous polyester resin B, particles having both the good heat-resistant storage stability and the fixability at low temperatures can be obtained. For example, when the amorphous polyester resin B and the crystalline polyester resin C are used together, the good heat-resistant storage stability is obtained by the crystallinity of the crystalline polyester resin C until a temperature immediately before the melting start temperature. At the melting start temperature, the melting of the crystalline polyester resin C causes a rapid decrease in viscosity (sharp melting properties). As a result, the crystalline polyester resin C is compatible with the amorphous polyester resin B, and both rapidly decrease in viscosity, which leads to good fixation.

The crystalline polyester resin C may be obtained from a polyhydric alcohol and a polycarboxylic acid or a derivative thereof, such as a polycarboxylic acid, a polycarboxylic anhydride, and a polycarboxylic ester.

In the present embodiment, the crystalline polyester resin C refers to a resin obtained by using, as described above, a polyhydric alcohol and a polycarboxylic acid or a derivative thereof, such as a polycarboxylic acid, a polycarboxylic anhydride, and a polycarboxylic ester. The crystalline polyester resin C does not include resins obtained by modifying a polyester resins, such as prepolymers and resins obtained by subjecting the prepolymer to a cross-linking and/or an elongation reaction.

### —Polyhydric Alcohol—

The polyhydric alcohol is not particularly limited and can be appropriately selected according to a purpose. Examples of the polyhydric alcohol include, but are not limited to, diols and trihydric or higher alcohols.

Examples of the diols include, but are not limited to, saturated aliphatic diols. Examples of the saturated aliphatic diols include, but are not limited to, linear saturated aliphatic diols and branched saturated aliphatic diols. Among such saturated aliphatic diols, linear saturated aliphatic diols are preferred, and linear saturated aliphatic diols having 2 to 12 carbon atoms are more preferred. When the saturated aliphatic diol is a linear saturated aliphatic diol, the crystallinity of the crystalline polyester resin is less likely to decrease, and the melting point is less likely to decrease. When the number of carbon atoms in the saturated aliphatic diol is 2 to 12, the material is readily available for practical use.

Examples of the saturated aliphatic diols include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosane decanediol. Among such saturated aliphatic diols, ethylene glycol, 1,4-butanediol, 1,6-hexanediol, 1,8-octanediol, 1,9-nonanediol, 1,10-decanediol, and 1,12-dodecanediol are preferred, because such saturated aliphatic diols tend to increase the crystallinity of the crystalline polyester resin C and tend to improve the sharp melting properties of the crystalline polyester resin C.

Examples of the trihydric or higher alcohol include, but are not limited to, glycerin, trimethylolethane, trimethylolpropane, and pentaerythritol. Such trihydric or higher alcohols may be used alone or in combination of two or more types.

### —Polycarboxylic Acid—

The polycarboxylic acid is not particularly limited and can be appropriately selected according to a purpose. Examples of the polycarboxylic acid include, but are not limited to, divalent carboxylic acids and trivalent or higher carboxylic acids.

Examples of the divalent carboxylic acids include, but are not limited to, saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and aromatic dicarboxylic acids such as phthalic acid, isophthalic acid, terephthalic acid, naphthalene-2,6-dicarboxylic acid, malonic acid, and mesaconic acid. Further examples include, but are not limited to, anhydrides and lower (number of carbon atoms from 1 to 3) alkyl esters of such compounds. In particular, from the viewpoint of carbon neutrality, plant-derived saturated aliphatic compounds having 12 or less carbon atoms are preferred.

Examples of the trivalent or higher carboxylic acids include, but are not limited to, 1,2,4-benzenetricarboxylic acid, 1,2,5-benzenetricarboxylic acid, 1,2,4-naphthalenetricarboxylic acid, and further, anhydrides of such carboxylic acids and lower (number of carbon atoms from 1 to 3) alkyl esters of such carboxylic acids.

Such trivalent or higher carboxylic acids may be used alone or in combination of two or more types.

The crystalline polyester resin C preferably includes a linear saturated aliphatic dicarboxylic acid having 4 to 12 carbon atoms and a linear saturated aliphatic diol having 2 to 12 carbon atoms. This provides a high crystallinity and excellent sharp melting properties to the crystalline polyester resin C, and thus, the excellent fixability at low temperatures can be obtained. Further, an example of a method of controlling the crystallinity and the softening point of the crystalline polyester resin C includes the following method. That is, the method includes designing and using a non-linear polyester and the like, obtained by performing at least one of “addition of a trivalent or higher polyhydric alcohol such as glycerin to the alcohol component”, and “addition of a trivalent or higher polycarboxylic acid such as trimellitic anhydride to the acid component” during synthesis of the crystalline polyester resin C, and performing condensation polymerization.

The molecular structure of the crystalline polyester resin C can be determined by an NMR measurement of a solution or a solid, and further, by X-ray diffraction, GC/MS, LC/MS, IR measurements, and the like. However, an example of a simple method includes a case where absorption from 6CH (out-of-plane bending vibration) of an olefin is observed at 965±10 cm⁻¹ or 990±10 cm⁻¹ in an infrared absorption spectrum.

Regarding the molecular weight of the crystalline polyester resin C, a crystalline polyester resin having a sharp molecular weight distribution as measured by GPC or the like and having a low molecular weight has the excellent fixability at low temperatures, and a crystalline polyester resin having a large amount of components with low molecular weight has a poor heat-resistant storage stability. Therefore, with regard to the crystalline polyester resin C, it is preferable that, in the molecular weight distribution of a fraction soluble in o-dichlorobenzene measured by GPC, in a molecular weight distribution diagram in which the horizontal axis is log (M) and the vertical axis is % by mass, a peak position is in the range of 3.5 to 4.0 and the full width at half maximum of the peak is 1.5 or less. It is also preferable that the weight average molecular weight (Mw) is 3,000 to 30,000, the number average molecular weight (Mn) is 1,000 to 10,000, and the ratio Mw/Mn of the weight average molecular weight (Mw) to the number average molecular weight (Mn) is 1 to 10. It is more preferable that the weight average molecular weight (Mw) is 5,000 to 15,000, the number average molecular weight (Mn) is 2,000 to 10,000, and Mw/Mn is 1 to 5.

From the viewpoint of affinity between the medium to be formed with an image such as paper and the resin, the acid value of the crystalline polyester resin C is preferably 5 mgKOH/g or more to achieve the desired fixability at low temperatures. In preparing fine particles by a phase inversion emulsification method, the acid value of the crystalline polyester resin C is more preferably 7 μmgKOH/g or more. On the other hand, to improve the hot offset properties, the acid value of the crystalline polyester resin C is preferably 45 mgKOH/g or less.

The hydroxyl value of the crystalline polyester resin C is preferably 0 to 50 mgKOH/g, and more preferably 5 to 50 μmgKOH/g, to achieve a predetermined fixability at low temperatures and good charging characteristics.

In the particles according to the present disclosure, the base particles preferably contain 0.05% by mass to 1% by mass of a divalent metal. When the divalent metal is contained in an amount of 0.05% by mass to 1% by mass, by using a metal salt during the production of the base particles to aggregate the raw material fine particles, the fine particles can be aggregated in a mild manner, so that base particles having a good particle size distribution and a high uniformity of the particle diameter can be obtained.

In the particles according to the present disclosure, the base particles preferably contain magnesium as the divalent metal, and the base particles preferably contain 0.1% by mass to 0.5% by mass of magnesium. This ensures that particles with a better particle size distribution and a high uniformity of the particle diameter can be obtained.

In the particles according to the present disclosure, the base particles preferably contain sodium, and the base particles more preferably contain more than 0.05% by mass of sodium. This ensures that particles with a better particle size distribution and a high uniformity of the particle diameter can be obtained.

In the particles according to the present disclosure, the base particles preferably contain magnesium and sodium, and more preferably contain more magnesium than sodium. Thus, by using a metal salt during the production of the particles to aggregate the raw material fine particles, it is easier to aggregate the fine particles in a milder manner, so that base particles having a better particle size distribution and a higher uniformity of the particle diameter can be obtained more reliably.

### ≤Resin Fine Particles>

The particles according to the present disclosure may include resin fine particles.

When the particles according to the present disclosure include resin fine particles, the resin fine particles adhere to the surface of the base particles and have a “core-shell structure” including a “core” in which the base particles form a core layer and a “shell” in which the resin fine particles form a shell layer.

In the core-shell structure, the surface of the core layer may be completely covered by the shell layer, or may not be completely covered by the shell layer.

Examples of a mode in which the surface of the core layer is not completely covered with the shell layer include a mode in which the core layer is covered with the shell layer in a mesh-like pattern, and a mode in which the core layer is partially exposed from the shell layer.

From the viewpoint of reducing the environmental load, the resin fine particles preferably include at least one of the polyethylene terephthalate and the polybutylene terephthalate.

The molecular weight distribution, the composition, the production method, and the form during the use of the polyethylene terephthalate or the polybutylene terephthalate are not particularly limited and can be appropriately selected according to a purpose. From the viewpoint of further reducing the environmental load, it is preferable to use, for example, recycled products, fiber waste not meeting specifications, or pellets, and it is more preferable to use recycled products processed into flakes.

The resin fine particles may include a resin obtained by a condensation reaction of an acid monomer unit and an alcohol monomer unit.

A monomer having a carboxy group is preferably employed for the acid monomer unit, and examples of the acid monomer unit include, but are not limited to, adipic acids, terephthalic acids, succinic acids, and rosin acids.

As the alcohol monomer unit, a monomer having a hydroxyl group is preferable, and examples of the alcohol monomer unit include, but are not limited to, a Bis-A-EO 2 μmol adduct, a Bis-A-PO 2 μmol adduct, 1,2 propanediol, trimethylolpropane, glycerin, and neopentyl glycol.

### <External Additive>

The particles according to the present disclosure include an external additive, and the external additive is coated with a hydroxide of a metal, i.e., a metal hydroxide.

The particles according to the present disclosure contain an external additive coated with a metal hydroxide.

R1≤R2 and R3≤R4 are established where R1 [log Ωcm] is a resistance value of the external additive coated with a metal hydroxide and R2 [log Ωcm] is a resistance value of the base particles, at 25° C. and a humidity of 50%, and R3 [log Ωcm] is a resistance value of the external additive coated with a metal hydroxide and R4 [log Ωcm] is a resistance value of the base particles, at 40° C. and a humidity of 70%.

When R1≤R2, the particles can easily accumulate and retain electric charges on the surfaces thereof. When R3≤R4, the particles can easily accumulate and retain electric charges on the surfaces thereof even under high temperature and high humidity conditions.

In the particles according to the present disclosure, the external additive is coated with a metal hydroxide, which makes it easier for intermolecular interactions to occur between the surface of the base particles or the resin fine particles and the hydroxyl groups present on the surface of the external additive, and thus, the external additive can be more reliably prevented from being separated from the base particles or the resin fine particles.

Generally, in high temperature and humidity conditions, the resistance of the external additive being an inorganic substance increases, whereas the resistance of the resin included in the base particles, which is prone to absorbing moisture, decreases. However, the external additive is coated with a metal hydroxide, and thus, the temperature dependence and the humidity dependence of the resistance value of the external additive can be controlled even under high temperature and high humidity conditions, and R1≤R2 and R3≤R4 can be maintained. The external additive coated with a metal hydroxide preferably includes an inorganic substance containing silica or a metal oxide, and more preferably includes an inorganic substance containing silica or a metal oxide with the surface being coated with a metal hydroxide.

The resistance value R1 [log Ωcm] is preferably 9.0 to 11.0. When R1 is 9.0 or more, the accumulated electric charge is easily retained, and when R1 is 11.0 or less, the electric charge is easily accumulated on the particle surface.

The resistance value R2 [log Ωcm] is preferably 11.5 or less, and more preferably 11.3 or less. When R2 is 11.5 or less, the electric charge is easily accumulated on the particle surface.

The resistance value R3 [log Ωcm] is preferably 8.0 to 10.8, and more preferably 8.5 to 10.5. When R3 is 8.0 or more, the electric charge accumulated under high temperature and high humidity conditions is easily retained, and when R3 is 10.8 or less, the electric charge is easily accumulated on the particle surface under high temperature and high humidity conditions.

The resistance value R4 [log Ωcm] is preferably 10.0 to 10.8, and more preferably 10.4 to 10.7. When R4 is 10.0 or more, the electric charge accumulated under high temperature and high humidity conditions is easily retained, and when R4 is 10.8 or less, the electric charge is easily accumulated on the particle surface under high temperature and high humidity conditions.

The external additive coated with the metal hydroxide may be placed on the surface of the base particles, or may be placed on the surface of the resin fine particles, or may be placed on the surface of the base particles present between the resin fine particles.

The inorganic substance containing silica is not particularly limited and can be appropriately selected according to a purpose. Examples of the inorganic substance containing silica include, but are not limited to, silicon oxide (silica) and silicone oil.

The metal oxide is not particularly limited and can be appropriately selected according to a purpose. Examples of the metal oxide include, but are not limited to, titanium oxide, aluminum oxide, iron oxide, copper oxide, zinc oxide, tin oxide, chromium oxide, cerium oxide, antimony trioxide, magnesium oxide, and zirconium oxide.

Among such metal oxides, silica and titanium dioxide are preferred from the viewpoint of adhesion between the base particles and the resin fine particles, and silica is more preferred.

Examples of the metal hydroxides include, but are not limited to, aluminum hydroxide, magnesium hydroxide, zinc hydroxide, and copper hydroxide. Such metal hydroxides may be used alone or in combination.

From the viewpoint of improving the excellent charging stability and a charge rise property, it is preferable that the outermost surface of the external additive is hydrophobized with a silane agent or the like.

A preferred example of the silane agent includes, but is not limited to, a silane coupling agent containing an alkylsilane such as isobutylsilane, methyltrimethoxysilane, methyltriethoxysilane, or octyltrimethoxysilane.

An external additive having an outermost surface hydrophobized with a silane agent or the like and being coated with a metal hydroxide can be obtained by treating hydrophilic inorganic fine particles serving as the external additive with a silane coupling agent containing an alkylsilane.

The average particle diameter of the external additive coated with the metal hydroxide is not particularly limited and can be appropriately selected according to a purpose, but the average particle diameter of the primary particles is preferably 1 nm to 200 nm, and more preferably 10 nm to 150 nm. When the average particle diameter of the external additive is within the above-mentioned preferred range, the external additive is less likely to be embedded in the base particles to allow the external additive to effectively exert its function, and uneven damage to the surface of an electrostatic latent image bearer can also be prevented.

The external additive coated on the metal hydroxide preferably contains at least one type of primary particles having an average particle diameter of 1 nm to 30 nm, and at least one type of primary particles having an average particle diameter of 50 nm to 200 nm. When the primary particles have an average particle diameter of 1 nm to 30 nm, the surface coverage by metal hydroxide is high and the charging stability is excellent, and when the primary particles have an average particle diameter of 50 nm to 200 nm, the external additive is easily blocked by the blade to improve filming and cleaning.

The specific surface area of the external additive coated with the metal hydroxide, as measured by the BET method, is preferably 20 μm²/g to 500 μm²/g, preferably 100 μm²/g to 400 m²/g, and more preferably 200 μm²/g to 300 μm²/g.

The content of the external additive coated on the metal hydroxide in the particles according to the present disclosure is not particularly limited and can be appropriately selected according to a purpose, but is preferably 0.5 parts by mass to 6.0 parts by mass, and more preferably 1.0 parts by mass to 4.0 parts by mass, with respect to 100 parts by mass of the base particles.

### <Other External Additives>

Inorganic fine particles, polymer fine particles, and the like may be employed for other external additives other than the above-mentioned external additives coated with metal hydroxide. The other external additives preferably contain two types of fine particles, that is, fine particles A of 100 nm or more and fine particles B of 10 to 50 nm, and the content ratio A/B of the fine particles A to the fine particles B is preferably 0.5 to 1.4.

Examples of inorganic fine particles as the other external additives include, but are not limited to, silica, alumina, fatty acid metal salts (such as zinc stearate and aluminum stearate), metal oxides (such as titanium oxide, barium titanate, magnesium titanate, calcium titanate, strontium titanate, aluminum oxide, iron oxide, copper oxide, zinc oxide, tin oxide, and antimony oxide), silica sand, clay, mica, wollastonite, diatomaceous earth, chromium oxide, cerium oxide, red ocher, antimony trioxide, magnesium oxide, zirconium oxide, barium sulfate, barium carbonate, calcium carbonate, silicon carbide, and silicon nitride. Among such inorganic fine particles, silica, alumina, and titanium oxide are particularly preferable.

The inorganic fine particles as the other external additives are preferably subjected to a surface treatment with a hydrophobic treatment agent to prevent deterioration of flow characteristics and charging characteristics even at high humidity.

Preferred examples of the hydrophobic treatment agent include, but are not limited to, silane coupling agents such as methyltrimethoxysilane, methyltriethoxysilane, and octyltrimethoxysilane, silylation agents, silane coupling agents having a fluorinated alkyl group, organic titanate coupling agents, aluminum coupling agents, silicone oils, and modified silicone oils.

Examples of the polymeric fine particles as the other external additives include, but are not limited to, polystyrene obtained by soap-free emulsion polymerization, suspension polymerization, and dispersion polymerization, fluoropolymers, polycondensation products such as methacrylic acid ester and acrylic ester copolymers, silicone, benzoguanamine, and nylon, and polymer particles formed of a thermosetting resin.

The other external additives may be placed on the surface of the base particles, or may be placed on the surface of the resin fine particles, or may even be placed on the surface of the base particles present between the resin fine particles.

Examples of commercially available titanium oxide fine particles include, but are not limited to, P-25 (manufactured by Nippon Aerosil Co., Ltd.), STT-30, STT-65C-S (both manufactured by Titan Kogyo, Ltd.), TAF-140 (manufactured by Fuji Titanium Industry Co., Ltd.), MT-150 W, MT-500B, MT-600B, and MT-150A (all manufactured by TAYCA, Co., Ltd.).

Examples of hydrophobically treated titanium oxide fine particles include, but are not limited to, T-805 (manufactured by Nippon Aerosil Co., Ltd.), STT-30A, STT-65S-S (both manufactured by Titan Kogyo, Ltd.), TAF-500T, TAF-1500T (both manufactured by Fuji Titanium Industry Co., Ltd.), MT-100S, MT-100T (both manufactured by TAYCA, Co., Ltd.), and IT-S (all manufactured by Ishihara Sangyo Kaisha, Ltd.).

The other external additives may be fine particles treated with silicone oil, and if necessary, oxide fine particles and inorganic fine particles treated with silicone oil obtained by heating can also be suitably used.

Examples of usable silicone oils include, but are not limited to, dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, acrylic, methacrylic-modified silicone oil, and α-methylstyrene-modified silicone oil.

Examples of inorganic fine particles include, but are not limited to, silica, aluminum oxide, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red ocher, antimony trioxide, magnesium oxide, zirconium oxide, barium sulfate, barium carbonate, calcium carbonate, silicon carbide, and silicon nitride. Among such inorganic fine particles, silica and titanium dioxide are particularly preferable.

The content of the other external additives is not particularly limited and can be appropriately selected according to a purpose, but is preferably 0.1% by mass to 5% by mass, and more preferably 0.3% by mass to 3% by mass, in the particles.

The average particle diameter of the primary particles of the other external additives is not particularly limited and can be appropriately selected according to a purpose, but is preferably 10 nm to 200 nm, and more preferably 10 nm to 100 nm. When the average particle diameter is 10 nm or more, the other external additives are less likely to be embedded in the base particles, so that the functions thereof are more likely to be effectively exerted, and when the average particle diameter is 200 nm or less, the surface of the electrostatic latent image bearer is less likely to be damaged.

### <Other Components>

The particles according to the present disclosure may contain other components in addition to the components described above. Examples of the other components include, but are not limited to, a release agent, a colorant, an electrostatic charge control agent, a cleanability improver, and a magnetic material.

### <<Release Agent>>

The release agent is not particularly limited and can be appropriately selected according to a purpose, but a release agent having a low melting point of 50° C. to 120° C. is preferred. When dispersed in the resin, the release agent having a low melting point effectively acts as a release agent at an interface between a fixing roller and the particles, so that good hot offset properties are obtained, even when no release agent is applied to the fixing roller.

Suitable examples of the release agent include, but are not limited to, waxes. Examples of the waxes include, but are not limited to, natural waxes, synthetic hydrocarbon waxes, and synthetic waxes. Examples of natural waxes include, but are not limited to, plant-based waxes such as carnauba waxes, cotton waxes, Japan waxes, and rice waxes; animal-based waxes such as beeswaxes and lanolin; mineral-based waxes such as ozokerite and ceresine; and petroleum waxes such as paraffin, microcrystalline waxes, and petrolatum. In addition to such natural waxes, examples of synthetic hydrocarbon waxes include, but are not limited to, Fischer-Tropsch waxes and polyethylene waxes, and examples of synthetic waxes include, but are not limited to, esters, ketones, and ethers. Further, fatty acid amides such as 12-hydroxystearamide, stearamide, phthalimide anhydride, and chlorinated hydrocarbons; polyacrylate homopolymers or copolymers such as poly-n-stearyl methacrylate and poly-n-lauryl methacrylate, which are crystalline polymer resins having low molecular weight (for example, n-stearyl acrylate-ethyl methacrylate copolymer); and crystalline polymers having long alkyl groups in a side chain may also be used as the wax. Such materials may be used alone or in combination of two or more types.

From the viewpoint of reducing the environmental load, plant-based waxes are preferred.

The melting point of the release agent is not particularly limited and can be appropriately selected according to a purpose. However, the melting point is preferably 50° C. to 120° C., and more preferably 60° C. to 90° C. When the melting point is 50° C. or higher, a negative effect of the release agent on the heat-resistant storage stability can be prevented. When the melting point is 120° C. or lower, cold offset during fixing at low temperatures can be effectively prevented. The melt viscosity of the release agent, obtained as a value measured at a temperature 20° C. higher than the melting point of the release agent, is preferably 5 cps to 1,000 cps, and more preferably 10 cps to 100 cps. When the melt viscosity is 5 cps or more, a decrease of the releasability can be prevented, and when the melt viscosity is 1,000 cps or less, the effects of a hot offset resistance and the fixability at low temperatures can be sufficiently exhibited. The content of the release agent in the particles is not particularly limited and can be appropriately selected according to a purpose. However, the content is preferably 0% by mass to 40% by mass, and more preferably 3% by mass to 30% by mass.

### <<Colorant>>

Known dyes and pigments can be employed for the colorant, and examples thereof include, but are not limited to, carbon black, nigrosine dye, iron black, Naphthol Yellow S, Hansa Yellow (10G, 5G, G), Cadmium Yellow, yellow iron oxide, ocher, chrome yellow, titanium yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, ANTHRAZANE Yellow BGL, Isoindolinone Yellow, red ocher, red lead, lead vermilion, Cadmium Red, Cadmium-Mercury Red, antimony vermilion, Permanent Red 4R, Para Red, Faise Red, Para-chloro Orthonitroaniline Red, Lithol Fast Scarlet G, Brilliant Fast Scarlet, Brilliant Carmine BS, Permanent Red (F2R, F4R, FRL, FRLL, F4RH), Fast Scarlet VD, Belkan Fast Rubin B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Polyazole Red, Chrome Vermilion, Benzidine Orange, Perinone Orange, Oil Orange, Cobalt Blue, Cerulean Blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), indigo, ultramarine blue, Prussian blue, Anthraquinone Blue, Fast Violet B, Methyl Violet Lake, cobalt violet, manganese violet, Dioxane Violet, Anthraquinone Violet, Chrome Green, Zinc Green, chromium oxide, Pyridian, Emerald Green, Pigment Green B, Naphthol Green B, Green Gold, Acid Green Lake, Malachite Green Lake, Phthalocyanine Green, Anthraquinone Green, titanium oxide, zinc oxide, and Lithopone, and mixtures of such colorants may be used.

### <<Electrostatic Charge Control Agent>>

The electrostatic charge control agent may be a typical electrostatic charge control agent, and examples of the electrostatic charge control agent include, but are not limited to, nigrosine-based dyes, triphenylmethane-based dyes, chromium-containing metal complex dyes, molybdate chelate pigments, rhodamine-based dyes, alkoxy-based amines, quaternary ammonium salts (including fluorine-modified quaternary ammonium salts), alkylamides, elemental phosphorus or phosphorus compounds, elemental tungsten or tungsten compounds, fluorine-based activators, metal salts of salicylic acid, and metal salts of salicylic acid derivatives. Specific examples of the electrostatic charge control agent include, but are not limited to, the nigrosine-based dye BONTRON 03, the quaternary ammonium salt BONTRON P-51, the metal-containing azo dye BONTRON S-34, the oxynaphthoic acid-based metal complex E-82, the salicylic acid-based metal complex E-84, the phenolic condensate E-89 (all manufactured by Orient Chemical Industries Co., Ltd.), the quaternary ammonium salt molybdenum complexes TP-302 and TP-415 (both manufactured by Hodogaya Chemical Co., Ltd.), the quaternary ammonium salt copy charge PSY VP2038, the triphenylmethane derivative copy blue PR, the quaternary ammonium salt copy charge NEG VP2036, and the copy charge NX VP434 (all manufactured by Hoechst AG), LRA-901 and the boron complex LR-147 (manufactured by Japan Carlit Co., Ltd.), copper phthalocyanine, perylene, quinacridone, azo pigments, and in addition, polymeric compounds having functional groups such as sulfonic acid groups, carboxyl groups, and quaternary ammonium salts. It is sufficient that the electrostatic charge control agent is used in an amount within a range in which the electrostatic charge control agent exhibits the performance without interfering with the fixability and the like. The electrostatic charge control agent is preferably contained in the base particles in an amount of 0.5% by mass to 5% by mass, and more preferably 0.8% by mass to 3% by mass.

### <<Cleanability Improver>>

The cleanability improver is not particularly limited and can be appropriately selected according to a purpose, as long as the cleanability improver is a substance added to the particles to remove a developer remaining on an electrostatic latent image bearer or a primary transfer medium after transfer. Examples of the cleanability improver include, but are not limited to, fatty acid metal salts such as zinc stearate, calcium stearate, and stearic acid, and polymer fine particles prepared by soap-free emulsion polymerization such as polymethyl methacrylate fine particles and polystyrene fine particles. The polymer fine particles preferably have a relatively narrow particle size distribution, and the volume average particle diameter is preferably from 0.01 μm to 1 μm.

### <<Magnetic Material>>

The magnetic material is not particularly limited and can be appropriately selected from known materials according to a purpose. Examples of the magnetic material include, but are not limited to, iron powder, magnetite, and ferrite. Among such magnetic materials, a white magnetic material is preferred in terms of color tone.

### (Characteristics of Particles)

### <Particle Diameter>

The particle diameter of the particles according to the present disclosure may be measured using a COULTER MULTISIZER III (manufactured by Coulter, Inc.), and the particle diameter of the particles can be measured, for example, as described below. First, 2 mL of a surfactant (sodium dodecylbenzenesulfonate, manufactured by Tokyo Chemical Industry Co., Ltd.) is added as a dispersant to 100 μmL of an electrolyte. It is noted that the electrolyte may be an approximately 1% aqueous solution of sodium chloride, prepared by using first-grade sodium chloride, and for example, ISOTON-II (manufactured by Coulter, Inc.) may be used. To a mixture of the electrolyte and the surfactant, 10 μmg of a sample of particles to be measured in terms of solid content is further added to obtain an electrolyte in which the sample is suspended. The electrolyte in which the sample is suspended is subjected to a dispersion treatment using an ultrasonic disperser for about 1 to 3 minutes, and the volume and the number of the particles are measured by using a COULTER MULTISIZER III with an aperture of 100 μm, to calculate the volume distribution and the number distribution. From the obtained distribution, the volume average particle diameter (Dv) of the particles is determined.

### <Method of Measuring Melting Point and Glass Transition Temperature (Tg)>

The melting point and the glass transition temperature (Tg) of the particles according to the present disclosure can be measured, for example, by using a differential scanning calorimeter (DSC) system (“Q-200”, manufactured by TA Instruments). Specifically, the melting point and the glass transition temperature of a target sample can be measured, for example, according to the following procedure. First, about 5.0 μmg of a sample of the target particles is filled into a sample container formed of aluminum, and the sample container is placed on a holder unit and set in an electric furnace. Next, in a nitrogen atmosphere, the sample is heated from −80° C. to 150° C. at a heating rate of 10° C./min (first temperature increase). Afterwards, the sample is cooled from 150° C. to −80° C. at a cooling rate of 10° C./min, and then, heated again to 150° C. at a heating rate of 10° C./min (second temperature increase). During each of the first temperature increase and the second temperature increase, a DSC curve can be measured by using, for example, a differential scanning calorimeter (“Q-200”, manufactured by TA Instruments). From the obtained DSC curves, the DSC curve at the first temperature increase can be selected by using an analysis program in the Q-200 system, to determine the glass transition temperature (Tg) of the target sample at the first temperature increase. Similarly, the DSC curve at the second temperature increase can be selected to determine the glass transition temperature (Tg) of the target sample at the second temperature increase.

From the obtained DSC curves, the DSC curve during the first temperature increase can be selected by using the analysis program in the Q-200 system, to determine the endothermic peak top temperature at the first temperature increase of the target sample as the melting point at the first temperature increase. Similarly, the DSC curve at the second temperature increase can be selected, to determine the endothermic peak top temperature during the second temperature increase of the target sample as the melting point at the second temperature increase.

Herein, the glass transition temperatures (Tg) and the melting points of the amorphous polyester resin A, the amorphous polyester resin B, and the crystalline polyester resin C, as well as other components such as the release agent, may also be determined by the same method as above, and unless otherwise specified, the endothermic peak top temperature and the glass transition temperature (Tg) during the second temperature increase are defined as the melting point and the glass transition temperature (Tg) of each target sample.

### <Average Particle Diameter and Average Circularity>

The average particle diameter and the average circularity of the particles according to the present disclosure can be measured using, for example, a flow-type particle image analyzer (FPIA-3000, manufactured by Sysmex Corporation). In a specific measurement method, for example, 100 ml to 150 ml of water from which solid impurities are removed in advance is filled into a container. 0.1 ml to 0.5 ml of a surfactant, preferably an alkylbenzene sulfonate salt, is added as a dispersant to the container, and then, about 0.1 g to 0.5 g of the sample of particles to be measured is added. The suspension liquid in which the sample is dispersed is subjected to a dispersion treatment for about 1 to 3 minutes by using an ultrasonic disperser. The average particle diameter and the average circularity are measured by using a flow-type particle image analyzer at a dispersion liquid concentration of 3000 particles/μl to 10000 particles/μl. The equivalent circle diameter is used as the particle diameter, and the average particle diameter is determined based on the equivalent circle diameter (number-based). The analysis conditions used in the flow-type particle image analyzer are listed below.
Particle diameter limits: 0.5 μm≤equivalent circle diameter (number-based)≤200.0 μm
Particle shape limits: 0.93<circularity≤1.00

The average circularity is defined as described below.

(Average circularity)=(Circumference of circle equal to projected area)/(Circumference of projected image)

### <Measurement of Molecular Weight>

The molecular weight of each constituent component of the particles according to the present disclosure can be measured, for example, by measuring a sample pretreated as described below under the following measurement conditions using the following measurement device and column.

### —Measurement Device—

Gel permeation chromatography (GPC) measurement device: GPC-8220GPC (manufactured by Tosoh Corporation)

### —Column—

Column: TSKgel Super HZM-H 15 cm triple column (manufactured by Tosoh Corporation)

### —Sample and Pretreatment—

Sample: 100 L of a sample containing 0.15% by mass of particles
Pretreatment: Particles to be measured are dissolved in tetrahydrofuran THF (containing a stabilizer, manufactured by Wako Pure Chemical, Ltd.) at 0.15% by mass, and then filtered through a 0.2 μm filter, to use the filtrate as a sample.

### —Measurement Conditions—

Temperature: 40° C.
Solvent: THE
Flow rate: 0.35 μmL/min

In measuring the molecular weight of a sample, the molecular weight distribution of the sample may be calculated from the relationship between the count number and the logarithmic value of a calibration curve prepared by using several types of monodispersed polystyrene standard samples. SHODEX STANDARD of Std. No. S-7300, S-210, S-390, S-875, S-1980, S-10.9, S-629, S-3.0, and S-0.580 μmanufactured by Showa Denko K.K. may be used as polystyrene standard samples for preparing the calibration curve. A refractive index (RI) detector may be used as the detector.

### (Method of Producing Particles)

A method of producing the particles according to the present disclosure will be described. The method of producing the particles according to the present disclosure includes an oil phase preparation step, an aqueous phase preparation step, a phase inversion emulsification step, a solvent removal step, an aggregation step, and a fusion step, and if desired, further includes other steps such as a shell forming step, a washing and drying step, an annealing step, a classification step, and an external additive addition step.

### <Oil Phase Preparation Step>

In the oil phase preparation step, first, at least one of polyethylene terephthalate (PET) and polybutylene terephthalate (PBT), which are the raw materials for the particles, and other resins, and, if necessary, a material such as a colorant, a prepolymer, and a release agent are dissolved or dispersed in an organic solvent to prepare an oil phase. A part of such materials may be added in the aggregation step described below.

A method of preparing the oil phase is not particularly limited and can be appropriately selected according to a purpose. An example of the method includes a method in which a raw material such as a resin is gradually added to an organic solvent while stirring the organic solvent to dissolve or disperse the raw material.

To disperse the raw material, known dispersers such as a bead mill and a disk mill may be used.

The raw materials used in the oil phase preparation step can be those explained above in the sections <Base Particles> and <Other Components>. Such raw materials may be used alone or in combination of two or more types.

The organic solvent is not particularly limited and can be appropriately selected according to a purpose. However, it is preferable to use a volatile solvent having a boiling point of less than 100° C., because it is easier to subsequently remove the organic solvent.

Examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, butyl acetate, methyl ethyl ketone, methyl isobutyl ketone, methanol, ethanol, and isopropyl alcohol. Such organic solvents may be used alone or in combination of two or more types.

When the resin to be dissolved or dispersed in the organic solvent is a resin having a polyester backbone, the organic solvent is preferably an ester-based solvent such as methyl acetate, ethyl acetate, and butyl acetate, or a ketone-based solvent such as methyl ethyl ketone and methyl isobutyl ketone, because the solubility is high. In particular, the organic solvent is preferably methyl acetate, ethyl acetate, or methyl ethyl ketone, because the organic solvent can be easily removed.

The amount of the organic solvent being used is not particularly limited and can be appropriately selected according to a purpose, but is preferably 40 parts by mass to 300 parts by mass, more preferably 60 parts by mass to 140 parts by mass, and even more preferably 80 parts by mass to 120 parts by mass, with respect to 100 parts by mass of the raw material of the base particles.

### <Aqueous Phase Preparation Step>

In the aqueous phase preparation step, an aqueous medium that will result in the aqueous phase is prepared.

The aqueous medium is not particularly limited and can be appropriately selected from known aqueous media. Examples of the aqueous medium include, but are not limited to, water, a solvent miscible with water, and a mixture thereof. From the viewpoint of granulation properties, the concentration of the solvent miscible with water is preferably equal to or lower than the saturation concentration in ion-exchanged water used in the phase inversion emulsification step.

The solvent miscible with water is not particularly limited, can be appropriately selected from known solvents, and examples thereof include, but are not limited to, alcohol, dimethylformamide, tetrahydrofuran, cellosolve solvents, lower ketones, and esters.

Examples of the alcohol include, but are not limited to, methanol, isopropanol, and ethylene glycol.

Examples of lower ketones include, but are not limited to, acetone and methyl ethyl ketone.

Example of the esters include, but are not limited to, ethyl acetate.

Such alcohols may be used alone or in combination of two or more types.

### <Phase Inversion Emulsification Step>

In the phase inversion emulsification step, the oil phase obtained in the oil phase preparation step is converted into oil droplets.

After neutralizing the oil phase, the aqueous phase is added to the neutralized oil phase, and phase inversion emulsification, in which the water-in-oil dispersion liquid is inverted into an oil-in-water dispersion liquid, is used to obtain a dispersion of oil droplets.

It is preferable to use a base for neutralizing the oil phase, and as a base used for neutralizing the oil phase, for example, any one of a basic inorganic compound or a basic organic compound may be used. Examples of the basic inorganic compound include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

The phase inversion emulsification is implemented by stirring. The stirring is implemented while uniformly mixing and dispersing the mixture by using a general-use stirrer or a dispersing device. A general-use stirrer and a dispersing device may be used in combination.

A stirring blade in the stirrer is not particularly limited and can be appropriately selected according to the viscosity of the solution. Examples of the stirring blade include, but are not limited to, stirring blades for low viscosity such as paddles and propellers, stirring blades for medium viscosity such as anchors and MAXBLEND stirring blades, and stirring blades for high viscosity such as helical ribbons.

Among such stirring blades, it is preferable to use a stirring blade for low viscosity or a stirring blade for medium viscosity, and it is more preferable to use a paddle or an anchor, because the volume average particle diameter of the oil droplets can be controlled within a preferred range.

When a stirring blade is used, the conditions such as the rotation speed, the stirring time, and the stirring temperature are not particularly limited and can be appropriately selected according to a purpose.

When a stirring blade is used, the rotation speed is not particularly limited, but is preferably 100 rpm to 1,000 rpm, and more preferably 200 rpm to 600 rpm.

The stirring time and the stirring temperature are not particularly limited and may be appropriately selected according to a purpose.

The dispersing device is not particularly limited, and examples thereof include, but are not limited to, an ultrasonic disperser, a bead mill, a ball mill, a roll mill, a HOMO MIXER, an ULTRA MIXER, a disperser mixer, a penetrating-type high-pressure dispersing device, a collision-type high-pressure dispersing device, a multi-hole type high-pressure dispersing device, an ultra-high pressure homogenizer, and an ultrasonic homogenizer.

If desired, a dispersant may be used. The dispersant is not particularly limited and can be appropriately selected according to a purpose. Examples of the dispersant include, but are not limited to, surfactants, inorganic compound dispersants poorly soluble in water, and polymer-based protective colloids. Such dispersants may be used alone or in combination of two or more types. In particular, surfactants are preferred.

The surfactants are not particularly limited, can be appropriately selected according to a purpose, and examples thereof include, but are not limited to, anionic surfactants, cationic surfactants, nonionic surfactants, and amphoteric surfactants.

The anionic surfactants are not particularly limited, can be appropriately selected according to a purpose, and examples thereof include, but are not limited to, alkylbenzene sulfonate, α-olefin sulfonate, and phosphoric acid ester. In particular, surfactants having a fluoroalkyl group are preferred.

### <Solvent Removal Step>

In the solvent removal step, the organic solvent is removed from the obtained dispersion of oil droplets.

To remove the organic solvent from the obtained dispersion of oil droplets, a method can be adopted in which the temperature of the entire system is gradually increased, while the mixture is stirred, so that the organic solvent in the oil droplets is completely evaporated and removed.

Alternatively, the organic solvent in the oil droplets can be completely removed by spraying the obtained dispersion of oil droplets into a dry atmosphere while stirring the dispersion of oil droplets. Further, the organic solvent may be evaporated and removed by reducing the pressure while stirring the dispersion of oil droplets. Alternatively, the organic solvent may be evaporated and removed by blowing gas onto the dispersion of oil droplets while stirring the dispersion of oil droplets.

Such members may be used alone or in combination.

The dry atmosphere into which the dispersion of oil droplets is sprayed is formed by a heated gaseous body such as air, nitrogen, carbon dioxide, and a combustion gas. In particular, various types of air streams heated to a temperature equal to or higher than the boiling point of the solvent having the highest boiling point are generally used as the dry atmosphere. A sufficient quality can be obtained by a short treatment such as using a spray dryer, a belt dryer, and a rotary kiln.

By removing the organic solvent from the dispersion of oil droplets obtained by the above-described method, a raw material microparticle dispersion can be obtained.

### <Aggregation Step>

In the aggregation step, the obtained raw material microparticle fine particle dispersion is stirred, while the particles are aggregated to a desired particle diameter, and thus, aggregated particles are obtained.

To aggregate the particles, existing methods such as adding an aggregating agent and adjusting the pH can be used. When an aggregating agent is added, the aggregating agent may be simply added. However, it is preferable to add the aggregating agent as an aqueous solution, because localized high concentration can be prevented. It is also preferable to add the aggregating agent gradually while monitoring the particle diameter of the raw material fine particles.

The temperature of the raw material fine particle dispersion during aggregation is preferably in a range from the [Glass transition temperature (Tg) of the resin being used] to the [Glass transition temperature (Tg) of the resin used+10° C.]. When the liquid temperature of the raw material microparticle dispersion is equal to or higher than the [Glass transition temperature (Tg) of the resin being used], aggregation proceeds appropriately and efficiently, whereas when the liquid temperature is equal to or lower than the [Glass transition temperature (Tg) of the resin being used+10° C.], the aggregation rate is not too fast, coarse particles are less likely to be generated, and it is easy to achieve a uniform particle diameter.

When the desired particle diameter is obtained, the aggregation is stopped. Methods for stopping the aggregation include, for example, adding a salt with a low ionic valence or a chelating agent, adjusting the pH, lowering the temperature of the dispersion, adding a large amount of an aqueous medium to dilute the concentration, and the like.

In the aggregation step, a colorant, a crystalline resin, and a release agent may be added. In such a case, the oil phase material is mixed with a dispersion of oil droplets dispersed in an aqueous phase, or with a raw material microparticle dispersion, and then aggregated to obtain aggregated particles in which the colorant, the crystalline resin, and the release agent are uniformly dispersed.

### —Aggregating Agent—

A general aggregating agent can be employed for the aggregating agent. The aggregating agent may be used alone or in combination of two or more types.

Metal ions function as cross-linking agents that cross-link the ends of the resin, and thus, for example, metal salts of monovalent metals such as sodium and potassium, metal salts of divalent metals such as calcium and magnesium, and metal salts of trivalent metals such as iron and aluminum can be employed for the aggregating agent.

In general, it is preferable to use a metal salt of a divalent metal from the viewpoint of facilitating a uniform particle diameter of the aggregated particles. When metal salts of divalent metals are employed for the aggregating agent, the cross-linking effect is not reduced, and even when there is a large difference in the structure of the resins contained, such as when a biomass resin, a non-crystalline resin having a large number of aromatic ring backbones, and a PET or PBT are used, the cross-linking reaction rate is not too fast, so that it is easy to maintain a good uniformity in the particle diameter of the aggregated particles. Among the metal salts of divalent metals, the metal salt of Mg has particularly good aggregation properties.

In the present embodiment, it is preferable to use a metal salt of Na having low ionic valence as the aggregating agent. When a metal salt of Na is employed for an aggregating agent, the aggregation can be efficiently terminated.

When a large amount of a metal used in an aggregating agent or the like remains in the particles, the chargeability deteriorate, and thus, the amount of the metal element in the base particles is preferably 0.05% by mass to 1% by mass. When the amount of the metal element in the base particles is 0.05% by mass or more, the amount of metal used for aggregation is sufficient, and the aggregation force is enough to easily achieve a uniform particle diameter. When the amount of the metal element is 1% by mass or less, the chargeability of the particles is not deteriorated. The type and the amount of metal in the particles can be adjusted according to the type and the amount of the aggregating agent and the terminator, and the washing conditions in the washing step.

### <Fusion Step>

In the fusion step, the aggregated particles obtained in the aggregation step are fused by a heating treatment to reduce the unevenness and obtain spherical particles to obtain a dispersion of fused aggregated particles. To fuse the aggregated particles, it is sufficient to heat the dispersion liquid of the aggregated particles while stirring the dispersion liquid. The temperature of the liquid is preferably in the range from the [Glass transition temperature (Tg) of the resin used+5° C.] to the [Glass transition temperature (Tg) of the resin used+30° C.].

### <Shell Forming Step>

The method of producing the particles according to the present disclosure may include the shell forming step, as necessary. In the shell forming step, a shell layer is formed on the spheronized particles obtained in the fusion step.

A method of forming a shell layer is not particularly limited and can be appropriately selected according to a purpose. An example of the method includes, but is not limited to, a method in which aggregated particles are prepared in the aggregation step, and then, a dispersion of resin fine particles that will result in the shell layer is added and stirred, an aqueous solution of magnesium sulfate is added, and then the fusion step is performed. Another method of forming the shell layer includes, for example, a method in which spherical particles having a desired particle diameter are produced in the fusion step, then a non-crystalline resin is added, and the aggregation step and the fusion step are repeated to form the shell layer.

### —Resin Fine Particles—

The resin fine particles may contain a resin obtained by a condensation reaction of an acid monomer unit and an alcohol monomer unit, and preferably contain at least one of the polyethylene terephthalate and the polybutylene terephthalate.

The molecular weight distribution, the composition, the production method, and the form during the use of the polyethylene terephthalate or the polybutylene terephthalate are not particularly limited and can be appropriately selected according to a purpose. From the viewpoint of further reducing the environmental load, it is preferable to use, for example, recycled products, fiber waste not meeting specifications, or pellets, and it is more preferable to use recycled products processed into flakes.

A monomer having a carboxy group is preferably employed for the acid monomer unit, and examples of the acid monomer unit include, but are not limited to, adipic acids, terephthalic acids, succinic acids, and rosin acids.

As the alcohol monomer unit, a monomer having a hydroxyl group is preferable, and examples of the alcohol monomer unit include, but are not limited to, a Bis-A-EO 2 μmol adduct, a Bis-A-PO 2 μmol adduct, 1,2 propanediol, trimethylolpropane, glycerin, and neopentyl glycol.

### <Washing and Drying Step>

In the washing and drying step, only the portions that will result in the base particles are extracted from the dispersion liquid of the fused aggregated particles obtained by the above-described method, and then, washed and dried.

The dispersion of the fused aggregated particles obtained by the above-described method contains an auxiliary material such as an aggregating agent in addition to the portions that will result in the base particles. Therefore, the dispersion of the fused aggregated particles is washed to extract only the portions that will result in the base particles from the dispersion. Examples of methods of washing the dispersion include, but are not limited to, a centrifugation method, a filtration method under a reduced pressure, and a filter pressing method. All of the above-mentioned methods produce a cake body of the portions that will result in the particles. When washing cannot be sufficiently performed in one operation, the obtained cake may be dispersed again in an aqueous solvent to form a slurry, and the process of extracting the portions that will result in the base particles by any one of the centrifugation method, the filtration method under a reduced pressure, the filter pressing method, or the like may be repeated. Alternatively, when the filtration method under a reduced pressure or the filter pressing method are used for washing, a method may be adopted in which the aqueous solvent is passed through the cake to wash away the auxiliary material absorbed by the portions that will result in the base particles. As the aqueous solvent used for washing, water and a mixed solvent obtained by mixing water with an alcohol such as methanol or ethanol can be used. From the viewpoint of a cost and the environmental load due to wastewater treatment or the like, it is preferable to use water.

The washed portions that will result in the base particles contain a large amount of the aqueous solvent, and thus, the aqueous solvent may be removed by drying to obtain only the portions that will result in the base particles.

In the drying method, for example, a dryer may be used, such as a spray dryer, a vacuum freeze dryer, a reduced pressure dryer, a stationary shelf dryer, a movable shelf dryer, a fluidized bed dryer, a rotary dryer, and an agitated dryer. The portions that will result in the dried particles are preferably dried until the moisture content is finally reduced to less than 1%. The portions that will result in the particles after drying form an aggregate obtained by softly aggregating the particles, and thus, if any inconvenience occurs during use, the soft aggregates may be crushed by utilizing a device such as a jet mill, a HENSCHEL mixer, a SUPER MIXER, a coffee mill, an OSTER blender, and a food processor to disintegrate the aggregates.

### <Annealing Step>

The method of producing the particles according to the present disclosure may include the annealing step, as necessary. A specific example of a method of performing annealing in the annealing step includes, but is not limited to, a method of storing the particles at a temperature in the range of the [Glass transition temperature (Tg) of the resin of the portions that will result in the base particles]±5° C. for ten hours after the above-described washing and drying step, when the raw material of the base particles contains a non-crystalline resin and a crystalline resin. With the annealing step, the non-crystalline resin and the crystalline resin are phase-separated, so that the fixability of the particles increases.

### <Classification Step>

The aggregates dried in the washing and drying step are classified using a known technique such as a sieve with a predetermined mesh size or an elbow jet classifier to obtain base particles having a desired particle diameter.

### <External Additive Addition Step>

External additives are added to the obtained base particles and mixed. At least one of the external additives to be added is an external additive coated with a metal hydroxide, and in addition, other external additives may be added and mixed.

A specific mixing technique includes, but are not limited to, a method in which an impact force is applied to the mixture by a blade rotating at high speed, and a method in which the mixture is introduced into a high-speed air stream and accelerated, and particles are caused to collide with each other or combined particles are caused to collide with an appropriate collision plate.

Examples of the device serving as a mixing means include, but are not limited to, ANGMILL (manufactured by Hosokawa Micron Corporation), a device obtained by modifying an I-type mill (manufactured by Nippon Pneumatic Mfg. Co., Ltd.) to reduce the pulverizing air pressure, a HYBRIDIZATION SYSTEM (manufactured by Nara Machinery, Co., Ltd.), a KRYPTRON SYSTEM (manufactured by Kawasaki Heavy Industries, Ltd.), and an automatic mortar.

The particles according to the present disclosure, which have the above-mentioned properties, can be effectively used as materials for image formation, such as a toner, a developer, a toner set, a toner storage unit, and an image forming apparatus.

### (Toner)

The toner according to the present disclosure contains the particles according to the present disclosure.

The toner according to the present disclosure has low environmental impact, is excellent in charging stability over time, and is excellent in charging stability even in a highly humid environment. Even when a biomass-derived resin is used, the toner according to the present disclosure is capable of providing an image having an excellent fixability at low temperatures and having an excellent image quality.

### (Developer)

The developer according to the present disclosure contains the toner according to the present disclosure, and may contain other components such as a carrier that are appropriately selected as necessary. The developer according to the present disclosure is capable of stably forming a high-quality image having an excellent transferability and the chargeability.

The developer according to the present disclosure may be a one-component developer or a two-component developer. However, in used in a high-speed printer and the like compatible with an increased information processing speed in recent years, a two-component developer is preferred in the viewpoint of a longer service life.

When the toner according to the present disclosure is used in the one-component developer, and even if the toner is consumed and resupplied, the particle diameter of the toner varies little, there is little filming of the toner on the developing roller, and the toner hardly fuses with components such as a blade used to obtain a thin layer of the toner, so that a high-quality image can be provided in the developing device.

When the toner according to the present disclosure is employed for the two-component developer, such a toner may be mixed with a carrier and used as the developer.

When the toner according to the present disclosure is used as the two-component developer, the particle diameter of the toner varies little, even when the toner is consumed and resupplied over a long period of time. Therefore, good and stable developing properties and images can be obtained, even when the toner is stirred during a long period of time in the developing device.

A content of the carrier in the two-component developer can be appropriately selected according to a purpose. However, the content is preferably 90 parts by mass to 98 parts by mass, and more preferably 93 parts by mass to 97 parts by mass, with respect to 100 parts by mass of the two-component developer.

The developer according to the present disclosure can be suitably used to form an image by various types of known electrophotographic methods such as a magnetic one-component development method, a non-magnetic one-component development method, and a two-component development method.

### <Carrier>

The carrier is not particularly limited and can be appropriately selected according to a purpose. However, the carrier preferably includes a core material and a coating layer that coats the core material, and it is more preferable that the coating layer is a resin layer.

### <<Core Material>>

A material of the core material is not particularly limited and can be appropriately selected according to a purpose. Examples of the material include, but are not limited to, manganese-strontium based materials having 50 emu/g to 90 emu/g of magnetization and manganese-magnesium based materials having 50 emu/g to 90 emu/g of magnetization. To ensure image density, it is preferable to use a highly magnetized material such as iron powder having 100 emu/g or more of magnetization and magnetite having 75 emu/g to 120 emu/g of magnetization. It is preferable to use a weakly magnetized material such as a copper-zinc based material having 30 emu/g to 80 emu/g of magnetization, because an impact of the developer in an upright state on the electrostatic latent image bearer can be alleviated, which is advantageous for obtaining high image quality. Such materials may be used alone or in combination of two or more types.

The volume average particle diameter of the core material is not particularly limited and may be appropriately selected according to a purpose, but is preferably from 10 μm to 150 μm, and more preferably from 40 μm to 100 μm. When the volume average particle diameter of the core material is 10 μm or more, an undesired phenomenon can be effectively prevented that the amount of fine powders in the carrier increases, a magnetization per particle decreases, and the carrier scatters. On the other hand, when the volume average particle diameter of the core material is 150 μm or less, an undesired phenomenon can be effectively prevented that a specific surface area decreases, which may cause the toner to scatter, and in a case of a full color having many solid areas, there may occur a poor reproduction, in particular, in the solid areas.

### <<Resin Layer>>

The resin layer may contain a resin and, if necessary, other components. The resin used in the resin layer may be any well-known material capable of imparting required chargeability. Specifically, it is preferable to use a silicone resin, an acrylic resin, or a combination thereof. A composition for forming the resin layer preferably contains a silane coupling agent.

An average thickness of the resin layer is preferably 0.05 μm to 0.50 μm.

### (Developer Storage Container)

The developer according to the present disclosure is contained in a developer storage container. The developer storage container is not particularly limited and can be appropriately selected from among known containers, and examples thereof include containers including a container main body and a cap.

The size, the shape, the structure, the material, and the like of the container main body are not particularly limited. However, the shape is preferably a cylindrical shape or the like, and particularly preferably, a shape in which spiral-shaped irregularities are formed on an inner circumferential surface so that, when the container main body is rotated, the developer therein can move to a side of a discharge port, and a part or all of the spiral-shaped irregularities function as bellows. The material is not particularly limited, but it is preferable that the material has a good dimensional accuracy. Examples of the material include, but are not limited to, resin materials such as polyester resins, polyethylene resins, polypropylene resins, polystyrene resins, polyvinyl chloride resins, polyacrylic acid, polycarbonate resins, ABS resin, and polyacetal resins.

The developer storage container can be easily stored and transported, for example, and has excellent handling properties. Therefore, the developer storage container can be attached to and detached from an image forming apparatus, a process cartridge, and the like, which will be described below, and used for replenishing the developer.

### (Toner Storage Unit)

The toner storage unit is capable of storing the toner according to the present disclosure. The term toner storage unit refers to a unit that stores a toner in a unit having a function of storing a toner. Examples of the toner storage unit include, but are not limited to, a toner storage container, a developing device, and a process cartridge.

The term toner storage container refers to a container storing a toner.

The term developing device refers to a device having means that stores and develops a toner.

The term process cartridge refers to a cartridge in which at least an electrostatic latent image bearer and a developing unit are integrally formed, that stores the toner, and is attachable to and detachable from an image forming apparatus. The process cartridge may further include at least one selected from a charging unit, an exposure unit, a cleaning unit, and the like.

When a toner storage unit that stores the toner according to the present disclosure is mounted on an image forming apparatus to form an image, an image can be formed using a toner having low environmental impact, being excellent in charging stability over time, and being excellent in charging stability even in a highly humid environment, and thus, a high-quality image may be obtained.

### (Image Forming Apparatus)

The image forming apparatus according to the present disclosure includes an electrostatic latent image bearer, an electrostatic latent image forming unit to form an electrostatic latent image on the electrostatic latent image bearer, and a developing unit containing the toner according to the present disclosure to develop the electrostatic latent image formed on the electrostatic latent image bearer with the toner according to the present disclosure to form a toner image, and may further include other components as necessary.

In addition to the electrostatic latent image bearer, the electrostatic latent image forming unit, and the developing unit described above, the image forming apparatus according to the present disclosure preferably includes a transfer unit that transfers the toner image to a medium to be formed with an image, and a fixing unit that fixes the transferred toner image onto a surface of the medium to be formed with an image, and may include other units such as a static elimination unit, a cleaning unit, a recycling unit, and a control unit.

In the developing unit, a toner image may be formed by using a developer including the toner according to the present disclosure, and, if necessary, further containing other components such as a carrier.

### <Electrostatic Latent Image Bearer>

The material, the shape, the structure, the size, and the like of the electrostatic latent image bearer are not particularly limited and can be appropriately selected from known electrostatic latent image bearers. Examples of the material of the electrostatic latent image bearer include, but are not limited to, inorganic photoconductors such as amorphous silicon and selenium, and organic photoconductors (OPC) such as polysilane and phthalopolymethine.

The shape of the electrostatic latent image bearer is not particularly limited and can be appropriately selected according to a purpose, but a cylindrical shape is preferred. The outer diameter of the electrostatic latent image bearer having the cylindrical shape is not particularly limited and can be appropriately selected according to a purpose. However, the outer diameter is preferably from 3 mm to 100 mm, more preferably from 5 mm to 50 mm, and particularly preferably from 10 mm to 30 mm.

### <Electrostatic Latent Image Forming Unit>

An electrostatic latent image forming unit is not particularly limited as long as the electrostatic latent image forming unit is a means for forming an electrostatic latent image on an electrostatic latent image bearer, and can be appropriately selected according to a purpose. For example, the electrostatic latent image forming unit may include a charging device being a charging unit that uniformly charges the surface of the electrostatic latent image bearer, and an exposure device being an exposure member that exposes the surface of the electrostatic latent image bearer in the form of the image.

The charging device is not particularly limited and can be appropriately selected according to a purpose. Examples of the charging device include, but are not limited to, contact charging devices including a conductive or semiconductive roll, a brush, a film, and a rubber blade, and non-contact charging devices utilizing corona discharge such as a corotron and a scorotron.

The charging device may have any form such as a magnetic brush and a fur brush, in addition to a roller, and can be selected according to the specification and form of the image forming apparatus.

The charging device is preferably a charging device that is arranged in contact with or not in contact with the electrostatic latent image bearer and charges the surface of the electrostatic latent image bearer by applying DC and AC voltages in a superimposed manner. The charging device is preferably a charging device that charges the surface of the electrostatic latent image bearer by applying DC and AC voltages in a superimposed manner to a charging roller. The charging roller is arranged in a non-contact manner close to the electrostatic latent image bearer by using a gap tape.

The charging device is not limited to a contact-type charging device, but it is preferable to use a contact-type charging member, because an image forming apparatus can be obtained in which the amount of ozone generated from the charging device is reduced.

The exposure device is not particularly limited and can be appropriately selected according to a purpose, as long as the exposure device can expose, in the form of the image to be formed, the surface of the electrostatic latent image bearer charged by the charging device. Examples of the exposure device include, but are not limited to, various types of exposure devices such as copying optical systems, rod lens array systems, laser optical systems, and liquid crystal shutter optical systems.

The light source used in the exposure device is not particularly limited and can be appropriately selected according to a purpose. Examples of the light source include, but are not limited to, general light-emitting devices such as fluorescent lamps, tungsten lamps, halogen lamps, mercury lamps, sodium lamps, light-emitting diodes (LEDs), semiconductor lasers (LDs), and electroluminescence (EL) sources.

To emit only light in a desired wavelength region, various types of filters can be used, such as a sharp cut filter, a band pass filter, a near infrared cut filter, a dichroic filter, an interference filter, and a color temperature conversion filter.

It is noted that the exposure device may employ a back-light method in which the electrostatic latent image bearer is exposed to light in the form of an image from the back side.

### <Developing Unit>

The developing unit is not particularly limited as long as the developing unit can develop the electrostatic latent image formed on the electrostatic latent image bearer to form a toner image, and can be appropriately selected according to a purpose. For example, the developing unit may suitably be one including a developing device that stores a toner and can apply the toner to an electrostatic latent image in a contact or non-contact manner, and is preferably a developing device including a container accommodating a toner.

The developing device may be a monochrome developing device or a multicolor developing device. A suitable example of the developing device includes, but is not limited to, a developing device including a stirring device that frictionally stirs the toner to charge the toner and a magnetic field generating portion fixed therein, and including a developer bearer such as a magnet roller rotatable with carrying the developer containing the toner on its surface.

### <Transfer Unit>

The transfer unit preferably includes a primary transfer unit that transfers the toner image onto an intermediate transfer body to form a composite transfer image, and a secondary transfer unit that transfers the composite transfer image onto a medium to be formed with an image. It is noted that the intermediate transfer body is not particularly limited and can be appropriately selected from known transfer bodies according to a purpose. A suitable example of the intermediate transfer body includes, but is not limited to, a transfer belt.

The transfer unit (the primary transfer unit and the secondary transfer unit) preferably includes at least a transfer device that peels and charges the toner image formed on the electrostatic latent image bearer onto the medium to be formed with an image. The number of the transfer unit may be one, or two or more.

Examples of the transfer device include, but are not limited to, a corona transfer device using corona discharge, a transfer belt, a transfer roller, a pressure transfer roller, and an adhesive transfer device.

It is noted that a typical example of the medium to be formed with an image is plain paper. However, the medium to be formed with an image is not particularly limited and can be appropriately selected according to a purpose from known medium to be formed with an image such as recording paper, as long as an unfixed image after development can be transferred on the medium to be formed with an image. For example, a PET base for overhead projectors (OHPs) may also be used.

### <Fixing Unit>

The fixing unit is not particularly limited and can be appropriately selected according to a purpose. However, a known heating and pressing portion is suitable. Examples of the heating and pressing portion include, but are not limited to, a combination of a heating roller and a pressure roller, and a combination of a heating roller, a pressure roller, and an endless belt.

The fixing unit is preferably a heating and pressing portion including a heating element with a heat generating element, a film in contact with the heating element, and a pressing member in pressure contact with the heating element via the film, and is capable of passing a medium to be formed with an image on which an unfixed image is formed between the film and the pressing member, and heating and fixing the image.

Normally, the heating temperature in the heating and pressing portion is preferably from 80° C. to 200° C.

The surface pressure in the heating and pressing portion is not particularly limited and can be appropriately selected according to a purpose, but is preferably from 10 N/cm² to 80 N/cm².

It is noted that in the present embodiment, according to a purpose, a known optical fixing device may be used together with or instead of the fixing portion, for example.

### <Other Units>

The image forming apparatus according to the present disclosure may further include, for example, a static elimination unit, a cleaning unit, a recycling unit, and a control unit as other units.

### <<Static Elimination Unit>>

The static elimination unit is not particularly limited, as long as the static elimination unit can apply a static elimination bias to the electrostatic latent image bearer. The static elimination unit can be appropriately selected from known static elimination devices, and a suitable example of the static elimination unit includes, but is not limited to, a static elimination lamp.

### <<Cleaning Unit>>

The cleaning unit may be any unit capable of removing the toner remaining on the electrostatic latent image bearer, and may be appropriately selected from among known cleaners. Examples of the cleaning unit include, but are not limited to, a magnetic brush cleaner, an electrostatic brush cleaner, a magnetic roller cleaner, a blade cleaner, a brush cleaner, and a web cleaner.

The image forming apparatus according to the present disclosure includes a cleaning unit by which it can improve the cleanability. That is, when the adhesive force between toner particles is controlled, the fluidity of the toner can be controlled, and thus, the cleanability can be improved. When the properties of the deteriorated toner are controlled, excellent cleaning quality can be maintained even under severe conditions such as a long life or a high temperature and humidity. The external additive can be sufficiently liberated from the toner on the electrostatic latent image bearer, and thus, a deposition layer (dam layer) of the external additive can be formed in a cleaning blade nip portion to achieve a high cleanability.

### <<Recycling Unit>>

The recycling unit is not particularly limited, and an example thereof includes, but is not limited to, a known conveyance unit.

### <<Control Unit>>

The control unit can control an operation of each of the above-mentioned components. The control unit is not particularly limited and can be appropriately selected according to a purpose, as long as the control unit can control an operation of each of the units described above. An example of the control unit includes, but is not limited to, a control device such as a sequencer and a computer.

In the image forming apparatus according to the present disclosure, an image can be formed using the toner according to the present disclosure, which has low environmental impact, is excellent in charging stability over time, and is excellent in charging stability even in a highly humid environment to obtain a high-quality image.

### (Image Forming Method)

The image forming method according to the present disclosure includes an electrostatic latent image forming step of forming an electrostatic latent image on an electrostatic latent image bearer, and a developing step of developing the electrostatic latent image formed on the electrostatic latent image bearer with the toner according to the present disclosure to form a toner image.

The image forming method according to the present disclosure preferably includes a transferring step of transferring the toner image to a medium to be formed with an image, and a fixing step of fixing the transferred transfer image onto the surface of the medium to be formed with an image in addition to the above-described electrostatic latent image forming step and the developing step.

The method may include a static elimination step, a cleaning step, a recycling step, and a controlling step as other steps, as necessary, in addition to such steps.

The image forming method can be suitably performed by the image forming apparatus. The electrostatic latent image forming step can be suitably performed by the electrostatic latent image forming unit. The developing step can be suitably performed by the developing unit. The transferring step can be suitably performed by the transfer unit. The fixing step can be suitably performed by the fixing unit. The other steps can be suitably performed by the other units.

### <Electrostatic Latent Image Forming Step>

The electrostatic latent image forming step is a step of forming an electrostatic latent image on an electrostatic latent image bearer, and can include a charging step of charging the surface of the electrostatic latent image bearer, and an exposing step of exposing the charged surface of the electrostatic latent image bearer to form an electrostatic latent image. The charging can be performed, for example, by using a charging device to apply a voltage to the surface of the electrostatic latent image bearer. The exposing can be performed, for example, by using an exposure device to expose the surface of the electrostatic latent image bearer in the form of an image. The forming of the electrostatic latent image can be performed, for example, by uniformly charging the surface of the electrostatic latent image bearer and then exposing the surface in the form of an image, and can be performed by an electrostatic latent image forming unit.

### <Developing Step>

The developing step is a step of successively developing an electrostatic latent image with a plurality of color toners to form a toner image. For example, the toner image can be formed by using the toner according to the present disclosure to develop the electrostatic latent image by the developing device.

In the developing step, the toner according to the present disclosure is used, and a toner image may be formed by using a developer containing the toner according to the present disclosure, and if necessary, other components such as a carrier.

For example, in the developing device, the toner and the carrier are mixed and stirred, and at this time, the toner is charged by friction, and is maintained in an upright state on the surface of a rotating magnet roller, to form a magnetic brush. The magnet roller is placed near the electrostatic latent image bearer, and therefore, a part of the toner forming the magnetic brush formed on the surface of the magnet roller moves to the surface of the electrostatic latent image bearer by electric attraction. As a result, the electrostatic latent image is developed by the toner to form a toner image on the surface of the electrostatic latent image bearer.

### <Transferring Step>

The transferring step is a step of transferring the toner image onto a medium to be formed with an image. In a preferred aspect of the transferring step, an intermediate transfer body is used to transfer a toner image by primary transfer onto the intermediate transfer body, and then, the toner image is transferred by secondary transfer onto the medium to be formed with an image. In a more preferred aspect of the transferring step, the transferring step includes a primary transfer step of using two or more color toners, preferably full color toners, and transferring the toner image onto the intermediate transfer body to form a composite transfer image, and a secondary transfer step of transferring the composite transfer image onto a medium to be formed with an image.

The transferring may be performed by charging the toner image onto the electrostatic latent image bearer by using a transfer charger, for example, and may be suitably performed by the transfer unit.

### <Fixing Step>

The fixing step is a step in which the toner image transferred to the medium to be formed with an image is fixed using a fixing device, and may be performed each time the toner image is transferred for each color developer onto the medium to be formed with an image, or may be performed simultaneously at once for each color developer in a superimposed state.

### <Other Steps>

The image forming method according to the present disclosure may further include other steps appropriately selected as necessary, such as a static elimination step, a cleaning step, a recycling step, and a controlling step.

### <<Static Elimination Step>>

The static elimination step is a step of applying a static elimination bias to the electrostatic latent image bearer to eliminate static electricity, and can be suitably performed by a static elimination portion.

### <<Cleaning Step>>

The cleaning step is a step of removing the toner remaining on the electrostatic latent image bearer, and can be suitably performed by the cleaning unit.

### <<Recycling Step>>

The recycling step is a step in which the toner removed in the cleaning step is recycled by the developing unit, and can be suitably performed by the recycling unit.

### <<Controlling Step>>

The controlling step is a step of controlling an operation of each of the above-described units, and can be suitably performed by the control unit.

In the image forming method according to the present disclosure, an image can be formed using the toner according to the present disclosure, which has low environmental impact, is excellent in charging stability over time, and is excellent in charging stability even in a highly humid environment to obtain a high-quality image.

Here, the image forming apparatus according to the present disclosure will be described with reference to the drawings. It is noted that the present disclosure is not limited to the embodiments described below, and may be changed within the scope conceivable by a person skilled in the art, including other embodiments, additions, modifications, omissions, and the like. The obtained embodiments are included within the scope of the present disclosure, as long as the operations or the effects of the present disclosure are exhibited in any aspect.

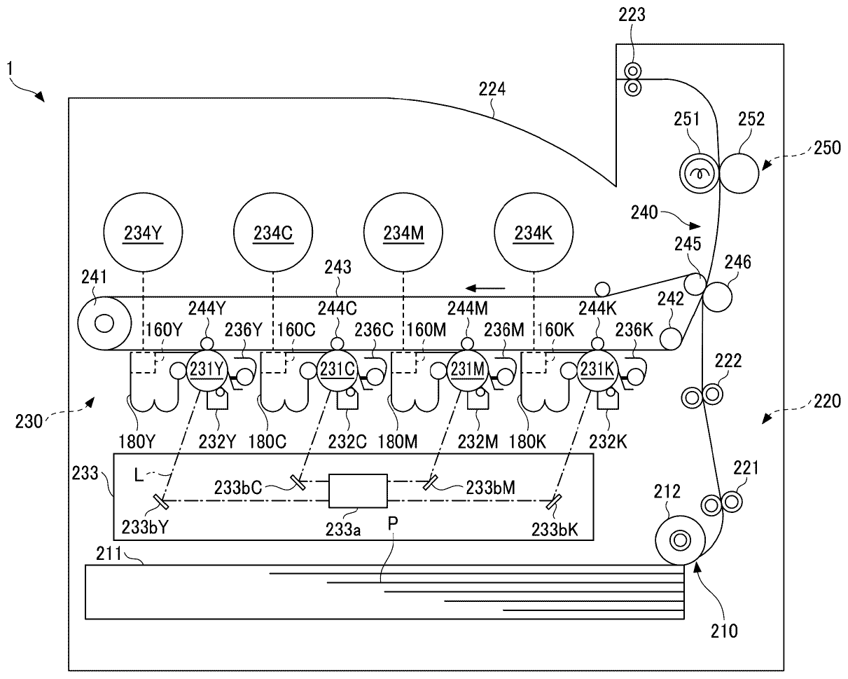

One aspect of a method for forming an image by the image forming apparatus according to the present disclosure will be described with reference to FIG. 1. It is noted that although a printer is described as an example of the image forming apparatus according to the present embodiment, the image forming apparatus according to the present disclosure is not particularly limited, as long as the image forming apparatus can form an image by using a toner, such as a copier, a facsimile, and a multifunction peripheral.

FIG. 1 is an image forming apparatus according to one embodiment of the present disclosure.

An image forming apparatus 1 includes a sheet feeder 210, a conveyor 220, an image forming device 230, a transfer device 240, and a fixing device 250.

The sheet feeder 210 includes a sheet feeding cassette 211 in which sheets P to be fed are stacked, and a sheet feeding roller 212 that feeds the one sheet P stacked in the sheet feeding cassette 211 at a time.

The conveyor 220 includes a roller 221 that conveys the sheet P fed by the sheet feeding roller 212 toward the transfer device 240, a pair of timing rollers 222 that hold a tip portion of the sheet P conveyed by the roller 221 therebetween and wait to deliver the sheet to the transfer device 240 at a predetermined timing, and a sheet discharge roller 223 that discharges the sheet P with the color toner image fixed thereto onto a sheet discharge tray 224.

The image forming device 230 includes, spaced at a predetermined interval in the following order from left to right in FIG. 1, an image forming unit 180Y that forms an image by using a developer containing a yellow toner, an image forming unit 180C using a developer containing a cyan toner, an image forming unit 180M using a developer containing a magenta toner, an image forming unit 180K using a developer containing a black toner, and an exposure device 233.

The image forming units 180Y, 180C, 180M, and 180K are arranged to be rotatable clockwise in FIG. 1, and respectively include photoconductor drums 231Y, 231C, 231M, and 231K being the electrostatic latent image bearers on each of which an electrostatic latent image and a toner image are formed, chargers 232Y, 232C, 232M, and 232K that uniformly charge a surface of the photoconductor drums 231Y, 231C, 231M, and 231K, and cleaners 236Y, 236C, 236M, and 236K that remove a toner remaining on the surfaces of the photoconductor drums 231Y, 231C, 231M, and 231K.

The image forming units 180Y, 180C, 180M, and 180K respectively include toner bottles 234Y, 234C, 234M, 234K being the developer storage containers that store each color toner, and sub-hoppers 160Y, 160C, 160M, and 160K that replenish the toner supplied from the toner bottles 234Y, 234C, 234M, and 234K.

It is noted that any one of the image forming units 180Y, 180C, 180M, and 180K is simply called the image forming unit.

The exposure device 233 irradiates the photoconductor drums 231Y, 231C, 231M, and 231K with laser light L emitted from a light source 233a, based on image information by reflecting the light on polygon mirrors 233bY, 233bC, 233bM, and 233bK rotated and driven by a motor.

The developer contains a toner and a carrier. The four image forming units 180Y, 180C, 180M, and 180K have substantially the same mechanical configuration, except that the developers used are different.

The transfer device 240 includes a driving roller 241, a driven roller 242, an intermediate transfer belt 243 rotatable counterclockwise in FIG. 1 as the driving roller 241 is driven, primary transfer rollers 244Y, 244C, 244M, and 244K arranged facing the respective photoconductor drums 231Y, 231C, 231M, and 231K across the intermediate transfer belt 243, and a secondary facing roller 245 and a secondary transfer roller 246 arranged to face each other across the intermediate transfer belt 243 at a transfer position of the toner image to the paper.

The fixing device 250 includes a fixing belt 251 including a heater therein and heating the sheet P, and a pressure roller 252 that rotatably applies a pressure to the fixing belt 251 to form a nip. Thus, heat and pressure are applied to the color toner image on the sheet P, and the color toner image is fixed.

The sheet P on which the color toner image is fixed is discharged onto the sheet discharge tray 224 by the sheet discharge roller 223, and thus, a series of image forming processes is completed.

### EXAMPLES

The embodiments will be described below in more detail with reference to examples and comparative examples, but the embodiments of the present disclosure are not limited to such examples and comparative examples.

### <Synthesis of Amorphous Polyester Resin A-1>

A reaction vessel included a cooling tube, a stirrer, and a nitrogen inlet tube. 3-methyl-1,5-pentanediol, isophthalic acid, and plant-derived sebacic acid were filled into the reaction vessel together with titanium tetraisopropoxide (1,000 ppm with respect to the resin component), so that the molar ratio of hydroxyl groups to carboxyl groups OH/COOH was 1.1, the configuration of the diol component was 100 μmol % of 3-methyl-1,5-pentanediol, the configuration of the dicarboxylic acid component was 73 μmol % of isophthalic acid and 23 mol % of sebacic acid, and the amount of trimethylolpropane in all monomers was 1.5 μmol %. Subsequently, the temperature was raised to 200° C. over about four hours, and then, raised to 230° C. over two hours, and the reaction was continued until no water was discharged. Afterwards, the mixture was further reacted for five hours under a reduced pressure of 10 mmHg to 15 mmHg to obtain an [Intermediate Polyester A-1].

Next, a reaction vessel included a cooling tube, a stirrer, and a nitrogen inlet tube. The solution of the obtained [Intermediate Polyester A-1] and isophorone diisocyanate (IPDI) was filled into the reaction vessel in a molar ratio (isocyanate groups of IPDI/hydroxyl groups of intermediate polyester) of 2.0, and diluted with ethyl acetate to obtain a 50% ethyl acetate solution. Subsequently, the solution was reacted at 150° C. for four hours to obtain [Prepolymer A-1].

The obtained [Prepolymer A-1] was stirred in a reaction vessel including a heating device, a stirrer, and a nitrogen inlet tube. Further, [Ketimine compound 1] was added dropwise to the reaction vessel in an amount so that the amount of amine of the [Ketimine compound 1] was equimolar to the amount of isocyanate in the [Prepolymer A-1]. After stirring at 45° C. for ten hours, a prepolymer extension product was extracted. The obtained prepolymer extension product was dried under a reduced pressure at 50° C. until the amount of residual ethyl acetate was 100 ppm or less, to obtain [Amorphous Polyester Resin A-1]. The obtained [Amorphous Polyester Resin A-1] had a glass transition temperature (Tg) of −51° C. and a weight average molecular weight (Mw) of 17,000.

### <Synthesis of Amorphous Polyester Resin B-1>

A four-neck flask included a nitrogen inlet tube, a dehydration tube, a stirrer, and a thermocouple. Bisphenol A 2-mol ethylene oxide adduct, bisphenol A 2-mol propylene oxide adduct, terephthalic acid, and adipic acid were added to obtain a mixture of bisphenol A 2-mol propylene oxide adduct and bisphenol A 2-mol ethylene oxide adduct in a molar ratio (bisphenol A 2-mol propylene oxide adduct/bisphenol A 2-mol ethylene oxide adduct) of 60/40. The mixture was charged with an acid in a molar ratio (terephthalic acid/adipic acid) of 97/3 and the molar ratio of hydroxyl groups to carboxyl groups OH/COOH was 1.3. The components were reacted with titanium tetraisopropoxide (500 ppm relative to the resin component) at normal pressure and 230° C. for eight hours. The mixture was further reacted for four hours at a reduced pressure of 10 mmHg to 15 mmHg. Subsequently, trimellitic anhydride was added to the reaction vessel in an amount of 1 μmol % with respect to the total resin components, and reacted at 180° C. and normal pressure for four hours to obtain [Amorphous Polyester Resin B-1]. The obtained [Amorphous Polyester Resin B-1] had a glass transition temperature (Tg) of 65° C. and a weight average molecular weight (Mw) of 9,000.

### <Introduction of P-1: Polyethylene Terephthalate (PET)>

The flake-like recycled PET [P-1] was mixed with the materials in the above <Synthesis of Amorphous Polyester Resin B-1> to obtain the solid content ratio shown in Table 1.

### <Synthesis of Crystalline Polyester Resin C-1>

A 5 L four-neck flask included a nitrogen inlet tube, a dehydration tube, a stirrer, and a thermocouple. Sebacic acid and ethylene glycol were filled into the flask, so that the molar ratio of hydroxyl groups to carboxyl groups OH/COOH was 0.9, and reacted together with titanium tetraisopropoxide (500 ppm with respect to the resin components) at 180° C. for ten hours. Subsequently, the temperature was raised to 200° C. and the mixture was reacted for three hours, and then, further reacted at a pressure of 8.3 kPa for two hours to obtain [Crystalline Polyester Resin C-1]. The obtained [Crystalline Polyester Resin C-1] had a melting point of 72° C. and a weight average molecular weight (Mw) of 20,000.

### <Production of Crystalline Polyester Resin Dispersion Liquid C-1>

A container included a stirring rod and a thermometer. 45 parts by mass of the [Crystalline Polyester Resin C-1] and 450 parts by mass of ethyl acetate were filled into the container. The temperature was raised to 80° C. while stirring, and the mixture was kept at 80° C. for five hours, and then, cooled to 30° C. for one hour. The mixture was dispersed by using a bead mill (ULTRAVISCOMILL, manufactured by Aimex Co., Ltd.) under conditions including a liquid delivery rate of 1 kg/hr, a disk peripheral speed of 6 μm/see, addition of 80 vol % of zirconia beads having a diameter of 0.5 mm, and 3 repetitions to obtain [Crystalline Polyester Resin Dispersion Liquid C-1]. The volume average particle diameter of the obtained crystalline polyester resin particles was 450 nm, and the solid content concentration of the crystalline polyester resin particles was 10% by mass.

### <Production of Polyester Resin for Shell SR>

Into a reaction tank including a cooling tube, a stirrer, and a nitrogen inlet tube, 7.5 parts by mass of adipic acid, 63.5 parts by mass of terephthalic acid, and 4.8 parts by mass of succinic acid as acid monomers, and 35.5 parts by mass of Bis-A-EO 2 μmol adduct, 58.2 parts by mass of Bis-A-PO 2 μmol adduct, 23.4 parts by mass of 1,2 propanediol, and 1 part by mass of trimethylolpropane as alcohol monomers were added so that the molar ratio of hydroxyl groups to carboxylic acid (OH/COOH) was 1.2, and 1,000 ppm of tetrabutoxytitanate was further charged as a condensation catalyst with respect to the total amount of monomers. The temperature was raised to 200° C. under a nitrogen stream over two hours, and then to 230° C. over eight hours, and the reaction was carried out for five hours while distilling off the water produced. Thereafter, the mixture was reacted for one hour under a reduced pressure of 5 mmHg to 15 mmHg, and cooled to 200° C. Then, 4.5 parts by mass of trimellitic anhydride was added and the mixture was reacted for one hour at normal pressure and 200° C. Then, the mixture was further reacted under a reduced pressure of 5 mmHg to 20 mmHg until the desired molecular weight was reached, to obtain [Polyester Resin for Shell SR]. Flake-shaped recycled PET [P-1] was mixed with the above-described acid monomer and alcohol monomer materials such that 30% by mass of the solid content was flake-shaped recycled PET [P-1].

### <Preparation of Polyester Resin Solution for Shell>

200 parts by mass of the [Polyester Resin for Shell SR] and 200 parts by mass of methyl ethyl ketone were placed in a container and mixed for 60 minutes at 5,000 rpm with a TK HOMO MIXER (manufactured by Primix Corporation) to obtain [Polyester Resin Solution for Shell 1]. The solid content concentration of the obtained [Polyester Resin Solution for Shell 1] was 50% by mass.

### <<Method of Calculating Solid Content Concentration of Polyester Resin Solution for Shell>>

0.9000 g to 1.0000 g of the [Polyester Resin Solution for Shell 1] was precisely weighed into an aluminum container and left to stand in a thermostatic chamber with an internal temperature set to 150° C. for one hour and then removed from the thermostatic chamber. The solid content concentration of the [Polyester Resin Solution for Shell 1] was then calculated from the remaining amount by the following formula:

$$Solid content concentration [ \% by mass ] = ( Amount remaining after leaving to stand at 150 ° C . for one hour [ g ] ) / ( Precisely weighted amount of [ Resin Solution for Shell 1 ] [ g ] ) \times 100$$

### <Preparation of Shell Aqueous Phase 1>

468 parts by mass of water and 132 parts by mass of methyl ethyl ketone were mixed and stirred to obtain a white transparent liquid. Such a liquid was designated as [Shell Aqueous Phase 1].

### <Preparation of Polyester Resin Emulsion for Shell SR>

While stirring 400 parts by mass of the solution of the [Polyester Resin Solution for Shell 1] with a TK HOMO MIXER (manufactured by Primix Corporation) at a rotation speed of 8,000 rpm, 28% ammonia water was added in an amount equivalent to a neutralization rate of 100% relative to the acid value of the [Polyester Resin for Shell SR] and mixed for ten minutes, and then, 600 parts by mass of the [Shell Aqueous Phase 1] was gradually added dropwise so that the [Polyester Resin Solution for Shell 1] was subjected to phase inversion emulsification. The [Polyester Resin Solution for Shell 1] was subjected to phase inversion emulsification, and the solvent was removed by an evaporator to obtain [Polyester Resin Emulsion for Shell SR].

### <Preparation of Wax Dispersion Liquid 1>

To 720 parts by mass of ion-exchanged water, 180 parts by mass of ester wax (WE-11, manufactured by NOF Corporation, synthetic wax made from plant-derived monomers, melting point 67° C.) and 17 parts by mass of an anionic surfactant (NEOGEN SC, sodium dodecylbenzenesulfonate, manufactured by Dai-ichi Kogyo Seiyaku Co., Ltd.) serving as a surfactant were added. This was dispersed using a homogenizer while being heated to 90° C., to obtain [Wax Dispersion Liquid 1]. The volume average particle diameter of the wax particles contained in the obtained the [Wax Dispersion Liquid 1] was 300 nm, and the solid content of the wax dispersion liquid was 25% by mass.

### <Preparation of Masterbatch (MB) 1>

1,200 parts by mass of water, 500 parts by mass of carbon black (PRINTEX 35, manufactured by Degussa AG) [DBP oil absorption amount=42 μmL/100 μmg, pH=9.5], and 500 parts by mass of [Amorphous Polyester Resin B-1] were added to and mixed in a HENSCHEL mixer (manufactured by Nippon Coke & Engineering Co., Ltd.). The mixture was kneaded by using two rolls at 150° C. for 30 minutes, and then, rolled to cool, and pulverized in a pulverizer to obtain [Masterbatch 1].

### (Production of Particles)

### [Base Particles 1]

### <Oil Phase Preparation Step>

50 parts by mass of [Amorphous Resin A-1], 50 parts by mass of [Crystalline Polyester Resin Dispersion Liquid C-1], 50 parts by mass of [Wax Dispersion Liquid 1], 550 parts by mass of [Amorphous Polyester Resin B-1], 300 parts by mass of [P-1], and 100 parts by mass of [Masterbatch 1] were placed in a container. The mixture was mixed for 60 minutes at 5,000 rpm with a TK HOMO MIXER (manufactured by Primix Corporation) to obtain [Oil Phase 1]. It is noted that the above blend amounts indicate the blend amounts of solid content in each raw material.

### <Aqueous Phase Preparation Step>

990 parts by mass of water, 20 parts by mass of sodium dodecyl sulfate, and 90 parts by mass of ethyl acetate were mixed and stirred to obtain a milky white liquid. The obtained liquid was defined as [Aqueous Phase 1].

### <Phase Inversion Emulsification Step>

While stirring 700 parts by mass of [Oil Phase 1] at a rotation speed of 8,000 rpm by using a TK HOMO MIXER, 20 parts by mass of 28% aqueous ammonia was added, and the mixture was mixed for ten minutes. Afterwards, 1,200 parts by mass of [Aqueous Phase 2] was gradually added dropwise to obtain [Emulsified Slurry 1].

### <Solvent Removal Step>

The [Emulsified Slurry 1] was filled into a container including a stirrer and a thermometer, and the solvent was removed at 30° C. for 180 minutes to obtain [Desolvated Slurry 1].

### <Aggregation Step>

To 1,000 parts by mass of the [Desolvated Slurry 1], 30 parts by mass of a 5% calcium chloride solution serving as an aggregating agent was added dropwise and stirred for five minutes. Subsequently, the temperature was raised to 60° C., and when the particle diameter reached 5.0 μm, 30 parts by mass of calcium chloride was added to terminate the aggregation step to obtain [Aggregated Slurry 1].

Only in Example 7, the following shell forming step was applied after the aggregation step, and the obtained [Slurry after shell forming step] was subjected to the following fusion step and washing and drying step to obtain [Base Particles 7].

### <Shell Forming Step>

To 1,000 parts by mass of the [Aggregated Slurry 1], 80 parts by mass of the [Polyester Resin Emulsion for Shell SR]
(solid content 25% by mass) were added, and while stirring, 20% by mass of an aqueous solution of magnesium sulfate was slowly added dropwise at a rate of 1 part by mass/minute until the particles in the system ceased to perform Brownian motion as observed under an optical microscope to obtain [Aggregated Slurry after Shell Forming Step].

### <Fusion Step>

The [Aggregated Slurry 1] or the [Aggregated Slurry after Shell Forming Step] was heated at 70° C. for three hours while stirring to obtain [Dispersed Slurry 1].

### <Washing and Drying Step>

100 parts by mass of the [Dispersed Slurry 1] were filtered under a reduced pressure, and then, the following operations (1) to (4) were performed three times to obtain [Filter Cake 1].

(1): 100 parts by mass of ion-exchanged water was added to the filter cake, and the mixture was mixed with a TK HOMO MIXER (at 12,000 rpm for ten minutes) and then filtered.

(2): 100 parts by mass of a 10% aqueous solution of sodium hydroxide was added to the filter cake in (1), and the mixture was mixed with a TK HOMO MIXER (at 12,000 rpm for 30 minutes), followed by filtration under a reduced pressure.

(3): 150 parts by mass of 10% hydrochloric acid was added to the filter cake in (2), and the mixture was mixed with a TK HOMO MIXER (at 12,000 rpm for 20 minutes) and then filtered.

(4): 300 parts by mass of ion-exchanged water was added to the filter cake in (3), and the mixture was mixed with a TK HOMO MIXER (at 12,000 rpm for ten minutes) and then filtered.

### <Classification Step>

The obtained [Filter Cake 1] was dried in a circulating air dryer at 45° C. for 48 hours, and sieved through a sieve having 75 μm mesh openings to obtain [Base Particles 1].

### [Base Particles 2 to 7]

[Base Particles 2] to [Base Particles 7] were obtained in the same manner as the [Base Particles 1], except that the amounts of recycled PET [P-1] and amorphous polyester [Resin B-1] added in the preparation of the [Base Particles 1] were changed as shown in Table 1. The resistance value R2 [log Ωcm] at 25° C. and a humidity of 50% and the resistance value R4 [log Ωcm] at 40° C. and a humidity of 70% were measured for the [Base Particles 1] to the [Base Particles 7]. The results are shown in Table 1. It is noted that the value of “recycled PET mass ratio [%] of all resins” is rounded off to the nearest whole number.

### [Resistance Value of Base Particles 1 to 7]

The resistance value R2 [log Ωcm] at 25° C. and a humidity of 50% and the resistance value R4 [log Ωcm] at 40° C. and a humidity of 70% were measured for the Base Particles 1 to 7 by the methods described below.

First, 3 g of each base particles was molded into a pellet having 40 mm in diameter and about 2 mm in thickness to prepare a measurement sample. Each measurement sample was prepared by molding using a BRE-32 type manufactured by Maekawa testing machine MFG, with a pressure device load of 6 MPa and a pressure time of one minute. Each of the prepared measurement samples was set on an SE-70 solid electrode (manufactured by Ando Electric Co., Ltd.). Then, the Log value [log Ωcm] being the common logarithm of the resistance when an AC current of 1 kHz is applied between the above-described electrodes, was measured using an AC bridge method measuring instrument including a TR-10C type dielectric loss measuring instrument, a WBG-9 oscillator, and a BDA-9 balanced point detector (all manufactured by Ando Electric Co., Ltd.). Thus, the resistance value R2 [log Ωcm] of the base particles 1 to 7 at 25° C. and a humidity of 50%, and the resistance value R4 [log Ωcm] of the base particles 1 to 7 at 40° C. and a humidity of 70% were determined. The results are shown in Table 1.

TABLE 1

| | Base particles | | | | | | |
|---|---|---|---|---|---|---|---|
| | 1 | 2 | 3 | 4 | 5 | 6 | 7 |
| Recycled PET additive | 300 | 350 | 100 | 500 | 800 | 200 | 0 |
| amount [pts · mass] | | | | | | | |
| Non-crystalline polyester | 550 | 500 | 750 | 370 | 75 | 600 | 800 |
| B-1 additive amount [pts · mass] | | | | | | | |
| Recycled PET mass ratio | 30 | 35 | 10 | 49 | 78 | 21 | 0 |
| in total resin [%] | | | | | | | |
| Resistance value R2 | 11 | 10.8 | 11.5 | 10.5 | 10.2 | 11.1 | 11.6 |
| [logΩcm] | | | | | | | |
| Resistance value R4 | 10.6 | 10.3 | 10.9 | 10 | 9.6 | 10.7 | 11.5 |
| [logΩcm] | | | | | | | |

### <<Preparation of External Additive 1>>

First, 100 g of silica particles (NIPSIL SP-200, BET specific surface area 200 μm²/g, manufactured by Tosoh Silica) produced by a liquid phase method was dispersed in 2 L of water and heated to 85° C. Next, an aqueous solution of aluminum chloride was added in an amount of 10% by mass when converted to Al₂O₃ with respect to the silica particles, and the pH was adjusted to 5.5 by using an aqueous solution of sodium hydroxide. Afterwards, the mixture was maintained while being stirred for 30 minutes, and then, the mixture was filtered and the residue on the filter material was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added, and the mixture was mixed for 15 minutes. Subsequently, the mixture was again dried at 120° C. to prepare an external additive 1.

### <<Preparation of External Additive 2>>

First, 100 g of silica particles (NIPSIL SP-200, BET specific surface area 200 μm²/g, manufactured by Tosoh Silica) produced by a liquid phase method was dispersed in 2 L of water and heated to 85° C. Next, an aqueous solution of zinc chloride was added in an amount of 10% by mass when converted to ZnO with respect to the silica particles, and the pH was adjusted to 8.0 by using an aqueous solution of sodium hydroxide. Afterwards, the mixture was maintained while being stirred for 30 minutes, and then, the mixture was filtered and the residue on the filter material was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added, and the mixture was mixed for 15 minutes. Subsequently, the mixture was again dried at 120° C. to prepare an external additive 2.

### <<Preparation of External Additive 3>>

First, 100 g of silica particles (NIPSIL SP-200, BET specific surface area 200 μm²/g, manufactured by Tosoh Silica) produced by a liquid phase method was dispersed in 2 L of water and heated to 85° C. Next, an aqueous solution of magnesium chloride was added in an amount of 10% by mass when converted to MgO with respect to the silica particles, and the pH was adjusted to 5.0 by using an aqueous solution of sodium hydroxide. Afterwards, the mixture was maintained while being stirred for 30 minutes, and then, the mixture was filtered and the residue on the filter material was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added, and the mixture was mixed for 15 minutes. Subsequently, the mixture was again dried at 120° C. to prepare an external additive 3.

### <<Preparation of External Additive 4>>

First, 100 g of silica particles (NIPSIL SP-200, BET specific surface area 200 μm²/g, manufactured by Tosoh Silica) produced by a liquid phase method was dispersed in 2 L of water and heated to 85° C. Next, an aqueous solution of iron chloride was added in an amount of 10% by mass when converted to FeO with respect to the silica particles, and the pH was adjusted to 8.5 by using an aqueous solution of sodium hydroxide. Afterwards, the mixture was maintained while being stirred for 30 minutes, and then, the mixture was filtered and the residue on the filter material was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added, and the mixture was mixed for 15 minutes. Subsequently, the mixture was again dried at 120° C. to prepare an external additive 4.

### <<Preparation of External Additive 5>>

First, 100 g of silica particles (NIPSIL SP-200 BET specific surface area 200 μm²/g, manufactured by Tosoh Silica) produced by a liquid phase method was dispersed in 2 L of water and heated to 85° C. Next, an aqueous solution of copper (II) chloride was added in an amount equivalent to 10% by mass when converted to CuO with respect to the silica particles, and the pH was adjusted to 9.0 by using an aqueous solution of sodium hydroxide. Afterwards, the mixture was maintained while being stirred for 30 minutes, and then, the mixture was filtered and the residue on the filter material was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added, and the mixture was mixed for 15 minutes. Subsequently, the mixture was again dried at 120° C. to prepare an external additive 5.

### <<Preparation of External Additive 6>>

First, 100 g of titanium oxide was dispersed in 2 L of water and heated to 85° C. Next, an aqueous solution of zinc chloride was added in an amount equivalent to 10% by mass when converted to ZnO with respect to the titanium particles, and the pH was adjusted to 8.5 with an aqueous sodium hydroxide solution. Afterwards, the mixture was maintained while being stirred for 30 minutes, and then, the mixture was filtered and the residue on the filter material was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added, and the mixture was mixed for 15 minutes. Subsequently, the mixture was again dried at 120° C. to prepare an external additive 6.

### <<Preparation of External Additive 7>>

First, 100 g of silica particles (NIPSIL SP-200, BET specific surface area 200 μm²/g, manufactured by Tosoh Silica) produced by a liquid phase method was placed in a small mixer, and 10 g of isobutyltrimethoxysilane was added and mixed for 15 minutes, and then again dried at 120° C. to prepare an external additive 7.

The resistance value R1 [log Ωcm] at 25° C. and a humidity of 50%, and the resistance value R3 [log Ωcm] at 40° C. and a humidity of 70% were measured for external additives 1 to 7. The results are shown in Table 2.

### [Resistance Value of External Additives 1 to 7]

The resistance value R1 [log Ωcm] at 25° C. and a humidity of 50% and the resistance value R3 [log Ωcm] at 40° C. and a humidity of 70% were measured for External Additives 1 to 7 by the methods described below.

First, 3 g of each external additive was molded into a pellet having 40 mm in diameter and about 2 mm in thickness to prepare a measurement sample. Each measurement sample was prepared by molding using a BRE-32 type manufactured by Maekawa testing machine MFG, with a pressure device load of 6 MPa and a pressure time of one minute. Each of the prepared measurement samples was set on an SE-70 solid electrode (manufactured by Ando Electric Co., Ltd.). Then, the Log value [log Ωcm] being the common logarithm of the resistance when an AC current of 1 kHz is applied between the above-described electrodes, was measured using an AC bridge method measuring instrument including a TR-10C type dielectric loss measuring instrument, a WBG-9 oscillator, and a BDA-9 balanced point detector (all manufactured by Ando Electric Co., Ltd.). Thus, the resistance value R1 [log Ωcm] at 25° C. and a humidity of 50% and the resistance value R3 [log Ωcm] at 40° C. and a humidity of 70% were determined for the external additives 1 to 7. The results are shown in Table 2.

TABLE 2

| | External additive | | | | | | |
|---|---|---|---|---|---|---|---|
| | 1 | 2 | 3 | 4 | 5 | 6 | 7 |
| Base material | Si | Si | Si | Si | Si | Ti | Si |
| Coating material | AlOH | ZnOH | MgOH | FeOH | CuOH | ZnOH | N/A |
| Resistance value R1 | 9.1 | 10.6 | 9.9 | 11.6 | 8.2 | 9.2 | 13 |
| [logΩcm] | | | | | | | |
| Resistance value R3 | 9.2 | 10.6 | 10 | 11.8 | 8.4 | 9.4 | 13.4 |
| [logΩcm] | | | | | | | |

Using a HENSCHEL mixer (manufactured by Mitsui Mining Co., Ltd.), 100 parts by mass of the [Base Particles 1], 1.5 parts by mass of hydrophobic silica particles having an average particle diameter of 50 nm, and 1.0 part by mass of the [External Additive 1] were mixed with respect to the [Base Particles 1] to obtain particles of Example 1.

The [Base Particles 1] to the [Base Particles 7] and the [External Additive 1] to the [External Additive 7] were combined as shown in Table 3 to prepare particles of Examples 2 to 7 and Comparative Examples 1 to 3 in the same manner as in Example 1.

The particles of Examples 1 to 7 and Comparative Examples 1 to 3 were evaluated for environmental compatibility, charging stability over time, and charging environmental stability based on the following evaluation criteria. The results are shown in Table 3.

TABLE 3

| | | | | | | | | Compar- | Compar- | Compar- |
|---|---|---|---|---|---|---|---|---|---|---|
| | | | | | | | | ative | ative | ative |
| | Example 1 | Example 2 | Example 3 | Example 4 | Example 5 | Example 6 | Example 7 | Example 1 | Example 2 | Example 3 |
| Base particles | 1 | 1 | 2 | 3 | 4 | 5 | 6 | 7 | 3 | 1 |
| Recycled PET | 300 | 300 | 350 | 100 | 500 | 800 | 200 | 0 | 100 | 300 |
| additive | | | | | | | | | | |
| amount [pts · mass] | | | | | | | | | | |
| Recycled PET | 30 | 30 | 35 | 10 | 49 | 78 | 21 | 0 | 10 | 30 |
| mass ratio in | | | | | | | | | | |
| total resin [%] | | | | | | | | | | |
| Resistance value | 11 | 11 | 10.8 | 11.5 | 10.5 | 10.2 | 11.1 | 11.6 | 11.5 | 11 |
| R2 [logΩcm] | | | | | | | | | | |
| Resistance value | 10.6 | 10.6 | 10.3 | 10.9 | 10 | 9.6 | 10.7 | 11.5 | 10.9 | 10.6 |
| R4 [logΩcm] | | | | | | | | | | |
| External additive | 1 | 2 | 3 | 1 | 5 | 6 | 1 | 1 | 4 | 7 |
| Base material | Si | Si | Si | Si | Si | Ti | Si | Si | Si | Si |
| Coating material | AlOH | ZnOH | MgOH | AlOH | CuOH | ZnOH | AlOH | AlOH | FeOH | N/A |
| Resistance value | 9.1 | 10.6 | 9.9 | 9.1 | 8.2 | 9.2 | 9.1 | 9.1 | 11.6 | 13 |
| R1 [logΩcm] | | | | | | | | | | |
| Resistance value | 9.2 | 10.6 | 10 | 9.2 | 8.4 | 9.4 | 9.2 | 9.2 | 11.8 | 13.4 |
| R3 [logΩcm] | | | | | | | | | | |

Evaluation result

| | | | | | | | | | | |
|---|---|---|---|---|---|---|---|---|---|---|
| Environmental | B | C | B | C | B | A | C | D | C | B |
| compatibility | | | | | | | | | | |
| Charging | A | A | A | B | C | C | A | B | B | D |
| stability | | | | | | | | | | |
| over time | | | | | | | | | | |
| Charging | A | C | B | A | A | C | A | A | D | D |
| environmental | | | | | | | | | | |
| stability | | | | | | | | | | |

### <Environmental Compatibility>

The environmental compatibility was evaluated based on the ratio of the environmentally compatible resin in the toner, according to the following evaluation criteria.

### (Evaluation Criteria)

A: The recycled resin is 70% or more
B: The recycled resin is 30% or more and less than 70%
C: The recycled resin is 1% or more and less than 30%
D: The recycled resin is less than 1%
   <Charging Stability over Time>

Using each developer, a durability test was carried out in which 100,000 sheets were continuously output using a character and image pattern with an image area ratio of 12%, and the change in the charging amount at that time was evaluated. A small amount of developer was sampled from the developing sleeve, and the change in the charging amount was determined by a blow-off method and evaluated according to the following criteria. It is noted that “C” or higher were deemed to be usable in the present disclosure.

### [Evaluation Criteria]

A: The change in charging amount is less than 3 μC/g
B: The change in charging amount is 3 μC/g or more and less than 6 μC/g
C: The change in charging amount is 6 μC/g or more and less than 10 μC/g
D: The change in charging amount is 10 μC/g or more

### <Charging Environmental Stability>

The charging environmental stability was measured as described below. That is, the sample was conditioned in an unsealed system for 30 minutes or more in an environment of 23° C. in temperature and 50% in relative humidity (M/M environment), 6.000 g of an initial carrier and 0.452 g of a toner were added to a stainless steel container, which was then sealed and operated for five minutes at the 150 μmark using a YS-LD (a shaker manufactured by Yayoi Corporation) to triboelectrically charge the sample by shaking approximately 1,100 times. For such a sample, Q1 is the charging amount measured using a general blow-off method (TB-200 μmanufactured by Toshiba Chemical Corporation) and Q2 is the charging amount measured in the same manner as Q1 in an environment of 35° C. in temperature and 80% in relative humidity. |Q1-Q2| is the charging environmental stability.

### [Evaluation Criteria]

A: The change in charging amount is less than 2 μC/g
B: The change in charging amount is 2 μC/g or more and less than 5 μC/g
C: The change in charging amount is 5 μC/g or more and less than 10 μC/g
D: The change in charging amount is 10 μC/g or more

From Table 3, it was confirmed that the particles of Examples 1 to 7 were evaluated as “C” or higher in all of the environmental compatibility, the charging stability over time, and the charging environmental stability, and thus, were suitable for use in the present disclosure.

In contrast, the particles obtained in Comparative Examples 1 to 3 were evaluated as “D” in at least one of the environmental compatibility, the charging stability over time, and the charging environmental stability, and were not suitable for use in the present disclosure.

From the above, it was demonstrated that the particles satisfying the constitution of the present disclosure had low environmental impact, were excellent in charging stability over time, and were excellent in charging stability even in a highly humid environment.

Aspects of the present embodiment include the following aspects, for example.

### ASPECT 1

Particles comprising: base particles containing a resin, the resin comprising polyester as a main component, the polyester comprising at least one of polyethylene terephthalate or polybutylene terephthalate; and an external additive coated with a hydroxide of a metal, in which R1≤R2 and R3≤R4 are satisfied,
where R1 [log Ωcm] is a resistance value of the external additive and R2 [log Ωcm] is a resistance value of the base particles, at 25° C. and a humidity of 50%, and R3 [log Ωcm] is a resistance value of the external additive and R4 [log Ωcm] is a resistance value of the base particles, at 40° C. and a humidity of 70%.

### ASPECT 2

The particles according to Aspect 1, in which the resistance value R1 [log Ωcm] is 9.0 to 11.0, the resistance value R2 [log Ωcm] is 11.5 or less,
the resistance value R3 [log Ωcm] is 8.0 to 10.8, and the resistance value R4 [log Ωcm] is 10.0 to 10.8.

### ASPECT 3

The particles according to Aspect 1 or 2, in which the metal comprises at least one selected from the group consisting of aluminum, zinc, magnesium, and copper.

### ASPECT 4

The particles according to any one of Aspect 1, 2, or 3, in which the external additive comprises silica.

### ASPECT 5

The particles according to any one of Aspect 1, 2, 3, or 4, in which a mass ratio of the at least one of polyethylene terephthalate or polybutylene terephthalate to the resin is 10% or more and less than 50%.

### ASPECT 6

The particles according to any one of Aspect 1, 2, 3, 4, or 5, in which a mass ratio of the at least one of polyethylene terephthalate or polybutylene terephthalate to the resin is 20% or more and less than 35%.

### ASPECT 7

The particles according to any one of Aspect 1, 2, 3, 4, 5, or 6, in which the resistance value R1 [log Ωcm] is 9.0 to 11.0, the resistance value R2 [log Ωcm] is 11.3 or less, the resistance value R3 [log Ωcm] is 8.5 to 10.5, and the resistance value R4 [log Ωcm] is 10.4 to 10.7.

### ASPECT 8

A toner including the particles according to any one of Aspect 1, 2, 3, 4, 5, 6, or 7.

### ASPECT 9

A developer including the toner according to Aspect 8.

### ASPECT 10

An image forming apparatus including:
an electrostatic latent image bearer,
an electrostatic latent image forming unit to form an electrostatic latent image on the electrostatic latent image bearer, and
a developing unit containing the toner according to Aspect 8, to develop the electrostatic latent image formed on the electrostatic latent image bearer with the toner to form a toner image.

### ASPECT 11

An image forming method including:
forming an electrostatic latent image on an electrostatic latent image bearer, and
developing the electrostatic latent image formed on the electrostatic latent image bearer with the toner according to Aspect 8 to form a toner image.

With the particles according to any one of Aspects 1 to 7, the toner according to Aspect 8, the developer according to Aspect 9, the image forming apparatus according to Aspect 10, and the image forming method according to Aspect 11, the conventional problems can be solved and the object of the present disclosure can be achieved.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. Particles comprising:
base particles containing a resin, the resin comprising polyester as a main component, the polyester comprising at least one of polyethylene terephthalate or polybutylene terephthalate; and
an external additive coated with a hydroxide of a metal,
wherein R1≤R2 and R3≤R4 are satisfied,
where R1 [log Ωcm] is a resistance value of the external additive and R2 [log Ωcm] is a resistance value of the base particles, at 25° C. and a humidity of 50%, and
R3 [log Ωcm] is a resistance value of the external additive and R4 [log Ωcm] is a resistance value of the base particles, at 40° C. and a humidity of 70%.

2. The particles according to claim 1, wherein the resistance value R1 [log Ωcm] is 9.0 to 11.0, the resistance value R2 [log Ωcm] is 11.5 or less, the resistance value R3 [log Ωcm] is 8.0 to 10.8, and the resistance value R4 [log Ωcm] is 10.0 to 10.8.

3. The particles according to claim 1, wherein the metal comprises at least one selected from the group consisting of aluminum, zinc, magnesium, and copper.

4. The particles according to claim 1, wherein the external additive comprises silica.

5. The particles according to claim 1, wherein a mass ratio of the at least one of polyethylene terephthalate or polybutylene terephthalate to the resin is 10% or more and less than 50%.

6. The particles according to claim 1, wherein a mass ratio of the at least one of polyethylene terephthalate or polybutylene terephthalate to the resin is 20% or more and less than 35%.

7. The particles according to claim 1, wherein the resistance value R1 [log Ωcm] is 9.0 to 11.0, the resistance value R2 [log Ωcm] is 11.3 or less, the resistance value R3 [log Ωcm] is 8.5 to 10.5, and the resistance value R4 [log Ωcm] is 10.4 to 10.7.

8. A toner comprising the particles according to claim 1.

9. A developer comprising the toner according to claim 8.

10. An image forming apparatus, comprising:
an electrostatic latent image bearer;
an electrostatic latent image forming unit to form an electrostatic latent image on the electrostatic latent image bearer; and
a developing unit containing the toner according to claim 8, to develop the electrostatic latent image formed on the electrostatic latent image bearer with the toner to form a toner image.

11. An image forming method, comprising:
forming an electrostatic latent image on an electrostatic latent image bearer; and
developing the electrostatic latent image formed on the electrostatic latent image bearer with the toner according to claim 8 to form a toner image.
